(19) United States
(12) Patent Application Publication
(10) Pub. No.: US 2019/0228479 A1
(43) Pub. Date: Jul. 25, 2019

(54) MULTIPLE PRODUCTS TRANSACTIONS

(71) Applicants: Hubert Williams, Ogden, UT (US); Lance H. Morgan, Perry, UT (US); Jason K. Coppieters, Brigham City, UT (US)

(72) Inventors: Hubert Williams, Ogden, UT (US); Lance H. Morgan, Perry, UT (US); Jason K. Coppieters, Brigham City, UT (US)

(73) Assignee: Maverik, Inc., Salt Lake City, UT (US)

(21) Appl. No.: 16/223,870

(22) Filed: Dec. 18, 2018

Related U.S. Application Data
(60) Provisional application No. 62/621,419, filed on Jan. 24, 2018.

(51) Int. Cl. G06Q 50/06; G06Q 20/18; G06F 3/0484; G06F 3/0482

(52) U.S. Cl. CPC G06Q 50/06; G06F 3/0482; G06F 3/04847; G06Q 20/18

(57) ABSTRACT

Disclosed are methods and systems for interrupting a fuel controller to allow the generation and display of customer interfaces at a fuel dispenser. Using this technology, a fueling station owner, for example, can generate custom displays on a fuel dispenser in order to provide customized information and selections to a customer that are provided by interrupting a fuel controller that controls the fuel dispenser. In some embodiments, the ability to interrupt a fuel controller enables a computer system to generate custom interface display at a fuel dispenser for the configuration of multiple products transactions. In other embodiments, a fuel controller interrupt is utilized to produce custom interface screens at a fuel dispenser that include loyalty or account information tied to the current user of the fuel dispenser. In other embodiments, a fuel controller interrupt is utilized to produce printed receipts at a fuel dispenser even when the related fueling transaction was not initiated at the fuel dispenser (e.g., was initiated inside the fueling station building.) In some embodiments, such printed receipts also include an indication of a balance remaining at the end of the transaction and provide a user with the ability to redeem the remaining balance at a later time using the indication on the printed receipt.

### CROSS-REFERENCE TO RELATED APPLICATIONS

This application claims the benefit of and priority to U.S. Provisional Patent Application Ser. No. 62/621,419 filed on Jan. 24, 2018, and entitled “Interrupting a Fuel Controller to Dynamically Control a Fuel Dispenser,” which application is expressly incorporated herein by reference in its entirety.

### BACKGROUND

Fueling stations are ubiquitous. Every day, hundreds of millions of transactions occur at fueling stations across the world. When fueling stations were initially created, a human pump attendant would personally help each customer with the task of adding fuel to their vehicle. This process was necessary to both increase the safety of the fueling process as well as to help uneducated consumers with the fueling process. During these interactions, a fueling attendant might have a conversation with a driver and suggest other types of services offered at the fueling station.

Over time, fueling stations have become more and more automated. With the advent of credit card payments at a fueling dispenser, a customer can now complete the entire process of fueling their vehicle quickly and entirely at the dispenser itself. While this automation allows for greater efficiency for the fueling process, it can limit the exposure of the customer to other goods and services offered by the fueling station.

More recently, fuel dispensers have added digital displays that aid in the transaction process by allowing users to select options, provide identification information, or otherwise interact with the fuel dispenser to complete a fueling transaction. For instance, a display may ask if the user wants a car wash. In order to manage these sorts of interactions, most fueling stations incorporate a fuel controller that is programmed to interface with fuel dispensers to handle the automated transaction procedures. Often, the fueling station leases or otherwise procures a fuel controller and/or fuel dispensers from third parties because the manufacturers of fuel dispensers implement proprietary protocols within the fuel dispensers to activate various functions of the dispensers. As such, a fuel controller is also required that can understand those protocols and provide an interface between the fuel dispensers and other systems at the fueling station, such as point of sale systems inside a fueling station building, such as a convenience store, or transaction authorization/verification systems.

While such fuel controllers have generally improved the automation of the fueling transaction process, there exists a need for increased interaction between the internal systems of a fueling station with the fuel dispensers themselves.

One area where improvements are needed is multiple products transactions. A multiple products transaction is a fueling transaction where a user dispenses multiple different types of fuels during a single transaction. This is a common occurrence for commercial truck drivers, for instance. An example of this is a user driving a diesel truck that is towing a trailer with a refrigeration unit(s). The engine of the truck itself requires a particular grade of diesel fuel, while the power generator necessary to run the refrigeration unit(s) requires a different grade or type of fuel. The driver may also need to pump an additive, such as diesel-exhaust fluid (DEF), into the truck as part of a multiple products transaction. Without the ability to perform a multiple products transaction, the driver may be required to perform two or three separate transactions to fuel the truck and trailer(s); this would be inconvenient for the driver and would potentially result in additional time and cost for the driver as well as the fueling station (e.g., additional transactions may incur increased fixed per transaction costs). Thus, multiple products transactions are employed to pump diesel fuel, fuel for the refrigeration unit(s), and/or a diesel-exhaust fluid additive, for example, as part of a single, authorized, transaction.

In typical systems in the prior art, a type of multiple products transaction is implemented by configuring a fuel controller with a set of default, pre-set options to dispense fuel in a predetermined sequence. For example, for fuel types “A,” “B,” and “C,” typical prior art systems present only certain fueling dispensing sequences, which the driver cannot change, e.g., fuel A, then fuel B, then fuel C, regardless of which fuel dispensing sequence is most convenient in a particular situation in light of truck/trailer sizes and fueling station spacing. A user then selects one of those pre-set fueling sequences and is required to dispense the corresponding fuels according to the predetermined fueling sequence. Thus, the predetermined sequences of the prior art, which the driver cannot change, can be inconvenient for a number of reasons, including the space and size limitations of trucks and fueling stations; such pre-set fueling sequences may even require a driver to move the truck multiple times during a multiple products transaction in order to comply with a pre-set fueling sequence.

As another problem, certain typical prior art systems only print pre-payment fueling receipts inside the fueling station building. In such typical prior art systems, if a user wants to prepay a fuel dispenser transaction using cash, or another prepayment method, the user must first enter the physical confines of the fueling station building and pre-pay for fuel with a cashier at a POS system, then later re-enter the building after fueling in order to obtain a printed receipt from the cashier.

Also in such typical prior-art systems, if the user did not fully dispense the prepaid or preauthorized amount of fuel, they must also return to the cashier inside the building to obtain a refund of the balance of preauthorized value. Thus, in such typical prior art systems, a user must enter the fueling station building twice or choose to forgo receiving a printed receipt or the balance of preauthorized value owed to them.

The subject matter claimed herein is not limited to embodiments that solve any disadvantages or that operate only in environments such as those described above.

### SUMMARY

Disclosed are methods, systems, electronic messaging, and computer program products for interrupting a fuel controller to allow the generation and display of customer interfaces at a fuel dispenser. The described embodiments enable operators of fuel dispensers managed by fuel controllers to dynamically modify the visual displays at the fuel dispensers in a manner that includes information customized to the user of the fuel dispenser. Using this technology, a fueling station owner, for example, can generate custom displays on a fuel dispenser in order to provide customized information and selections to a customer that are provided by interrupting a fuel controller that controls the fuel dispenser.

Typical fuel controllers control how fuel is selected, processed, and dispensed by a customer. The present invention enables a computer system located at the fueling station to modify the typical operation of a fuel dispenser in order to provide customized information and selections to customers.

In some embodiments, the ability to interrupt a fuel controller enables a computer system to generate custom interface display at a fuel dispenser for the configuration of multiple products transactions. In other embodiments, a fuel controller interrupt is utilized to produce custom interface screens at a fuel dispenser that include loyalty or account information tied to the current user of the fuel dispenser. In other embodiments, a fuel controller interrupt is utilized to produce printed receipts at a fuel dispenser even when the related fueling transaction was not initiated at the fuel dispenser (e.g., was initiated inside the fueling station building.) In some embodiments, such printed receipts also include an indication of a balance remaining at the end of the transaction and provide a user with the ability to redeem the remaining balance at a later time using the indication on the printed receipt.

The present invention contemplates that certain communications are handled by fuel controller 120 according to a bypass or “interrupted” protocol (e.g., such as when communications are transmitted through bypass communications controller 122) or according to a default or “uninterrupted” protocol (e.g., such as when transmitted through default communications protocol 124.) Bypass communication controller 122 functions by allowing computer system 110 to bypass, or otherwise circumvent, the default protocols preprogrammed within fuel controller 120.

In one embodiment, a fuel controller bypass signal is generated by a computer system remote from the fuel controller. Upon receipting the bypass signal, the fuel controller is placed into an interrupted state. As a result, at least some of the operations of a fuel dispenser normally controlled by the fuel controller are instead able to be handled by the computer system. This allows the computer system to generate custom display screens at the fuel controller.

In one embodiment, a bypass signal is transmitted to a fuel controller to place it in an interrupted state. Once in the interrupted state, a computer system generates a series of custom configuration interfaces for display at the fuel dispenser. For example, the configuration interfaces may enable a user to dispense multiple fuels during a single dispensing transaction. The custom configuration interfaces may specifically allow a user to select the types of fuels to be dispensed as well as the sequence to dispense them.

In another embodiment, a computer system places a fuel controller in an interrupted mode by sending the fuel controller a bypass signal. The computer system then generates custom screens at a fuel dispenser that include loyalty information specific to the current user of the fuel dispenser. The computer system also queries remote data storage devices in order to identify known information about the user and/or to make or gather predictive information about the user. This predictive information is then used to generate other custom interface screens that include promotional offers or other loyalty related information customized to the current user of the fuel dispenser.

In another embodiment, one solution is provided that allows for transaction receipts to be printed at a fuel dispenser even when the transaction is initiated at a location other than the fuel dispenser, such as, for example, inside a fueling station building that also operates as a convenience store. In one embodiment, a user prepays for a particular amount of fuel at a computer system located inside the fueling station building that is remote from the fuel dispenser. The user then dispenses the fuel. The user can dispense all of the preauthorized fuel and subsequently receive a receipt printed at the fuel dispenser that includes transaction details. However, if the user does not dispense all of the preauthorized fuel the user subsequently receives a receipt printed at the fuel dispenser that includes an indication of a balance of value owed to the user among other possible information. The printed receipt or other indication can then be used by the user to obtain a refund of the remaining value or to apply the remaining value to subsequent transactions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof that are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1a illustrates an example of a system for dynamically generating custom interfaces at a fuel dispenser that has been placed in an interrupted state.

FIG. 1b is a functional diagram of an embodiment of a system configured to dynamically generate and display custom user interfaces at a fuel dispenser.

FIG. 2 is a flow diagram articulating an embodiment of a method for dynamically generating and displaying custom user interfaces at a fuel dispenser.

FIG. 3a is a functional diagram used in illustrating a multiple-fuels dispensing operation.

FIGS. 3b through 3j illustrate functional diagrams of a series of sample display interfaces that might be viewed and operated by a user during a multiple products transaction.

FIG. 4 is a flow diagram articulating an embodiment for executing a multiple products transaction at a fuel dispenser.

FIG. 5a illustrates a functional diagram for generating custom interfaces that include loyalty information.

FIG. 5b illustrates a flow diagram of a method for implementing a loyalty rewards program in conjunction with a fueling station.

FIGS. 6a and 6b illustrate flow diagram for three embodiments of a method for generating receipts at a fuel dispenser for transactions initiated at a location other than the fuel dispenser.

FIG. 6c illustrates a functional diagram of one advantage of generating receipts at a fuel dispenser for preauthorized dispensing transactions.

FIG. 7 illustrates an example of a computing system that may be used to employ embodiments described herein.

### DETAILED DESCRIPTION OF THE PREFERRED EMBODIMENTS

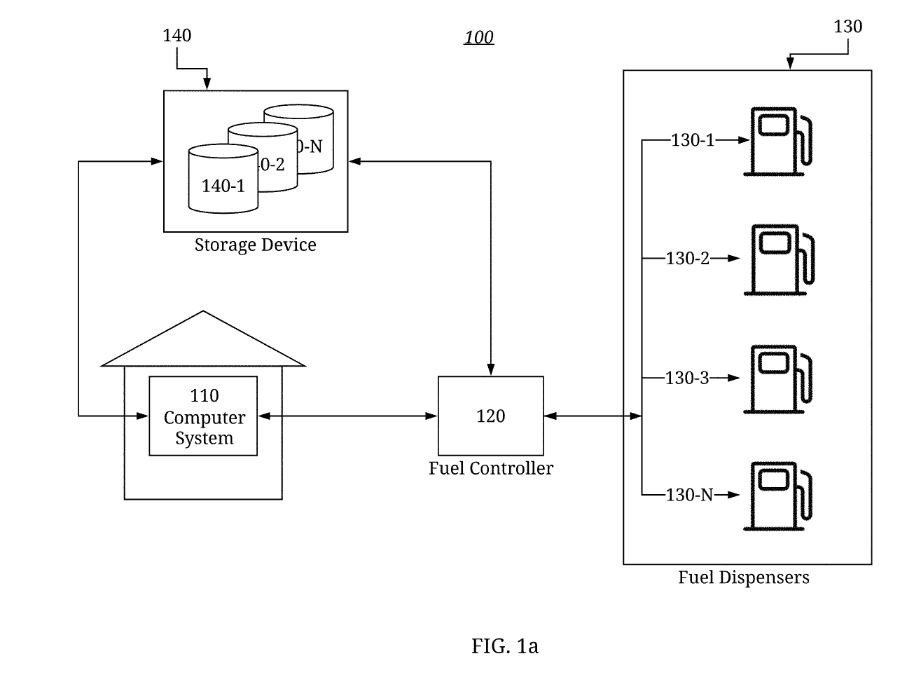

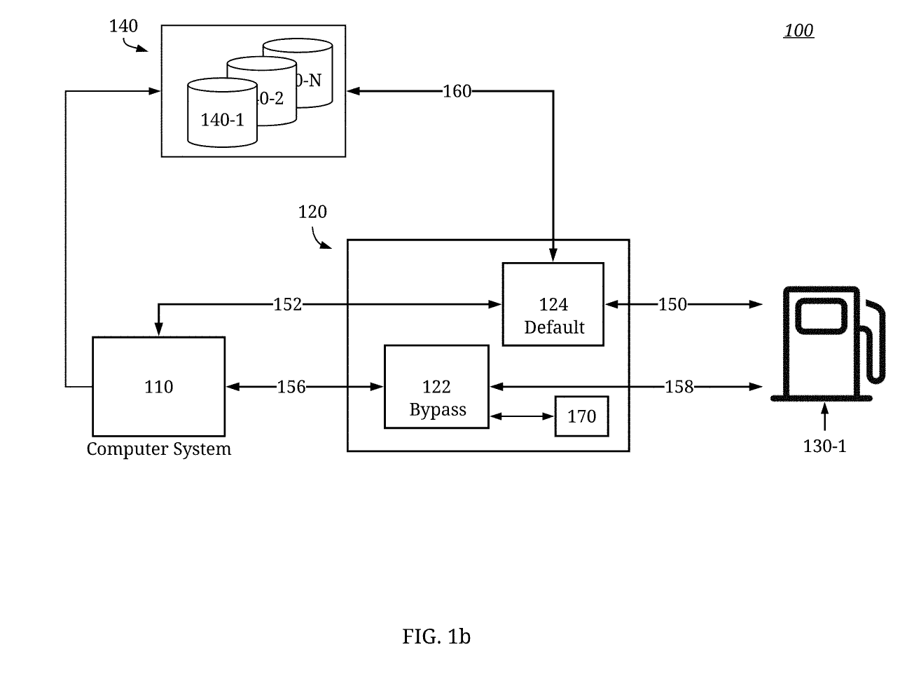

FIG. 1a illustrates an example of a system 100 that may be used to employ the embodiments described herein. FIG. 1a includes a computing system 110 operated from within a fueling station building (e.g., inside a convenience store, for example.) For example, computing system 110 may be a point of sale system used to manage and track all transactions occurring at the fueling station including both fuel dispensing transactions occurring at the fuel dispensers 130 outside of the fueling station building, as well as any transactions that occur within the fueling station building (e.g., food and beverage sales.)

The computer system 110 is connected to a fuel controller 120 and to computer storage 140. Computer storage 140, as illustrated, includes storage device 140-1, storage device 140-2, and storage device 140-N. It is appreciated that storage 140 may include any number of storage devices and that, as illustrated, storage devices 140-1, 140-2, and 140-N are included merely to illustrate the fact that computer system 110 may be connected to a single storage device or to multiple storage devices.

In one embodiment, computing system 110 connects to storage 140 over a network or other remote communication protocol, while in other embodiments, storage 140 is local storage or even integrated within computing system 110. Accordingly, the computing system 110 has access to information storage, such as storage 140, and can communicate with storage 140 in a manner that allows information to be stored at storage 140 and/or retrieved from storage 140. It should also be appreciated that in some embodiments, computing systems other than computing system 110 can access storage 140. In some embodiments, storage system 140 is a remote storage array that includes individual storage devices 140-1, 140-2, and 140-N. In such scenarios, computing system 110 can access at least one of the individual storage devices. In some scenarios, other computing systems can access storage 140 and the various individual storage devices contained therein.

In some embodiments, storage 140 includes multiple different physical storage arrays. For example, storage 140 may include multiple physical storage devices located in different locations and accessible by the various devices within system 100 over different network. As such, while illustrated as a single storage 140 within FIG. 1a, it should be appreciated that, for example, each individual storage device 140-1, 140-2, and/or 140-N may be implemented individually and discretely from one or all of the other individual storage devices.

As noted, FIG. 1a also includes fuel controller 120. Fuel controller 120 is connected to computing system 110 by any suitable communications means. Such communication means allows for two-way communication between fuel controller 120 and computing system 110. In some embodiments, communication is provided by through a physical connection such as a by cabling, while in other embodiments wireless communication is additionally or alternatively utilized. Further, the particular communications protocol utilized to allow communications between computing system 110 and fuel controller 120 is not important to the present invention. Rather, the present invention requires only that some form of two-way communication is enabled between fuel controller 120 and computing system 110.

In some embodiments, fuel controller 120 is also connected to fuel dispensers 130. As illustrated, fuel dispensers 130 include individual fuel dispensers 130-1, 130-2, 130-3, and 130-N. It should be appreciated that in other embodiments, fuel dispensers 130 includes a single fuel dispenser, while in other embodiments, fuel dispensers 130 include more than the four illustrated dispensers. In some embodiments, fuel dispenser 130 may include 5, 10, 20, or “N” fuel dispensers as denoted by individual fuel dispenser 130-N.

Fuel controller 120, then, is connected to the individual fuel dispensers within fuel dispenser 130 by any suitable means that allows for two-way communication between fuel controller 120 and individual fuel dispensers. In some embodiments, communication is provided through a physical connection such as a by cabling between fuel controller 120 and each individual fuel dispenser, while in other embodiments wireless communication is additionally or alternatively utilized. Further, the particular communications protocol utilized to allow communications between fuel controller 120 and the various individual fuel dispensers is not important to the present invention. Rather, the present invention requires only that some form of two-way communication is enabled between fuel controller 120 and fuel dispensers 130.

In some embodiments, fuel controller 120 is also connected to storage 140 including one or more of individual storage devices 140-1 through 140-N. In some embodiments, fuel controller 120 can access the individual storage device(s) that computer system 110 can access. In other embodiments, storage 140 includes individual storage devices dedicated to communication with fuel controller 120.

### Interrupting a Fuel Controller to Enable Custom Interactions

Turning now to FIG. 1b, a more detailed illustration of a system 100 is shown. In the illustrated embodiment, system 100 includes a computer system 110 such as the computer system 110 shown in conjunction with FIG. 1a. FIG. 1b also illustrates individual storage devices 140-1, 140-2, and 140-N such as the storage devices illustrated in FIG. 1a. It should be appreciated that while in some embodiments computer system 110, as shown in B, is the same as computer system 110 of FIG. 1a, in other embodiments, computer system 110 of FIG. 1b differs from the system of FIG. 1a.

The embodiment of FIG. 1b also illustrates a fuel controller 120 that includes a default communications controller 124 and a bypass communications controller 122. Notably, both communications controllers are communicatively connected to computer system 110 through communications channel 152 (with regard to default communications controller 124) and through communications channel 156 (with regard to bypass communications controller 122.) Likewise, default communications controller 122 is communicatively connected to a fuel dispenser (e.g., any of the fuel dispensers 130 illustrated in FIG. 1a) over communications channel 150 while bypass communications controller 122 is configured to communicate over communications channel 158.

While communications channels 150, 152, 156, and 158 are illustrated as separate communications channels, it should be appreciated that fuel controller 120 can communicate with computer system 110 and the various fuel dispensers over these or other communications channels. Additionally, in some embodiments, the separately shown communications channels may be combined to function over a single physical or wireless communications channel. In other words, for some embodiments, the individual communications channels illustrated in FIG. 1 are abstract representations of the concept that various sub-controllers within a fuel controller, such as 120, are capable of communicating with other portions of system 100.

As illustrated, each of the communications channels within system 100 enable two-way communication between the various connected communicative devices. While system 100 illustrates two-way communication for all communication channels, it should be appreciated that in practice, some of the various communications channels may implement only one-way communication.

Returning to fuel controller 120, two sub controllers are illustrated. Default communications controller 124 is configured to handle communications between a fuel dispenser and computer system 110 while fuel controller 120 is in a default or “uninterrupted” state. For example, prior to commencing a dispensing transaction, a fuel dispenser, such as fuel dispenser 130-1, is configured to display a default interface at a digital display integrated within the fuel dispenser. In some embodiments, the default interface may include a generic “welcome” message, or include default branding content (e.g., a logo or a slogan identifying the fueling station.)

In some embodiments, this default information is presented at the fuel dispenser based on the fuel controller being pre-programmed to display default content. For example, prior to commencement of a transaction, default communication controller 124 of fuel controller 120 transmits default content to fuel dispenser 130-1 for display at a digital display of the fuel dispenser.

In some embodiments, fuel controller 120 is pre-programmed with the particular content that will be displayed using default controller 124. For example, fuel controller 120 may include internal storage where content can be stored and retrieved. In other embodiments, fuel controller 120 may retrieve default display information over communications channel 160 from a remote storage device such as storage device 140-2. Upon retrieval of default information, fuel controller 120 utilizes default communications controller 124 to transmit the default information over communications channel 150 for display at fuel dispenser 130-1.

Next, upon commencing a fueling transaction at fuel dispenser 130-1, a user provides information at the fuel dispenser 130-1. For example, in response to a default display message sent by default communications controller 124, a user provides a payment method such as a credit card by swiping the credit card at fuel dispenser 130-1. Upon receiving the user input, fuel dispenser 130-1 transmits the input over communications channel 150 back to default communications controller 124 of fuel controller 120. In some embodiments, fuel controller 120 then transmits the user input over communications channel 152 from default communications controller 124 to computer system 110. For example, the user input may be transmitted to computer system 110 in order to authorize the payment method.

Upon performing whatever task is necessary with the information received from fuel controller 120, in some embodiments, computing system 110 then transmits information back to default communications controller 124 of fuel controller 120 over communications channel 152. For example, computing system 110 transmits an indication that the transaction has been authorized to fuel controller 120. As a result, default communications controller 124 then authorizes fuel dispenser 130-1 to dispense fuel to the customer.

In some embodiments, upon receiving the information from computing system 110, default communications controller 124 transmits different default content to fuel dispenser 130-1 that is relevant to the new status of the transaction. For example, after receiving an authorization indication from computing system 110, default communications controller 124 transmits new default content prompting the user to select a fuel grade for dispensing.

In some embodiments, the result of receiving the new user input at the fuel dispenser 130-1 is to repeat the sequence described above that occurred as the result of receiving the initial user input. In other embodiments, some communications do not involve one or more of the computer system 110, fuel controller 120, or fuel dispenser 130-1. For example, in some embodiments, once a first user input is processed by computer system 110 (e.g., a credit card authorization), subsequent communications relating to the authorized transaction occur only between the fuel controller 120 and the authorized fuel dispenser such as fuel dispenser 130-1. It should be appreciated that in some transactions, a mix of communication transmission occur in such a manner that some involve a full round-trip communication such as the one described above in conjunction with the first user input, while other communications occur without one or more of the described components being involved.

As illustrated above, each of the steps described with respect to the uninterrupted state occur based on a protocol preconfigured and controlled by fuel controller 120. It is particularly noted that the content communicated to fuel dispenser 130-1 at each step of an uninterrupted-state transaction includes only content preconfigured to be transmitted by the fuel controller 120 based on the transaction sequence currently being processed.

For example, in some embodiments, fuel controller 120 presents default content at the display of fuel dispenser 130-1. Based on receiving user input initiating a fueling event (e.g., swiping a credit card), fuel controller 120 passes the received input to computer system 120 for authorization. Once authorized, fuel controller 120 presents second default content at fuel dispenser 130-1 instructing the user to select a grade of fuel for dispensing. Next, the user selects a fuel and begins dispensing the fuel. During fuel dispensing, fuel controller 120 maintains two-way communication with fuel dispenser 130-1 to, for example, monitor the amount of fuel being dispensed. Upon completion of dispensing fuel, the user then sends an indication that fueling has completed (e.g., places the fuel hose back in the fuel dispenser holder.) Fuel dispenser 130-1 then transmits an indication to fuel controller 124 indicating that the user has finished dispensing fuel. It should be noted that during fueling, the fuel dispenser communicates various content to the fuel dispenser without interaction from computing system 110. However, upon completion of the fueling process, fuel controller 120 then again communicates to computer system 110, including providing various information such as the total amount of fuel dispensed so that the user can be charged according to the authorized payment method.

The default transaction processing protocol and communications sequences described above are intended to illustrate the “default” protocols that are commonly preprogrammed within the logic of a fuel controller, such as fuel controller 120. The default process occurs while the fuel controller is in an “uninterrupted state.” As such, it should be appreciated that the terms default and uninterrupted, when used in association with the status of a fuel controller can be used interchangeably unless otherwise indicated.

Returning to FIG. 1b, fuel controller 120 also includes bypass communications controller 122 that is connected to computer system 110 over communications channel 156 and is also connected to a fuel dispenser, such as fuel dispenser 130-1, over communications channel 158. In some embodiments, bypass communications controller 122 is implemented within fuel dispenser 120 by means of software or logic. In other embodiments, bypass communications controller 122 is implemented within the hardware of fuel controller 120 such that communications occur using communications channels managed by a hardware controller. However, within the parameters of the present invention, various methods of implementing bypass communications controller 122 within fuel controller 120 may be employed.

Thus, the present invention contemplates only that certain communications are handled by fuel controller 120 according to a bypass or “interrupted” protocol (e.g., such as when communications are transmitted through bypass communications controller 122) or according to a default or “uninterrupted” protocol (e.g., such as when transmitted through default communications protocol 124.)

It should also be noted that in some embodiments, such as system 100, bypass communication controller 122 is not directly connected to storage 140. This may be important because the function of bypass communication controller 122 is to allow computer system 110 to dictate the content passed by fuel controller 120 to a fuel dispenser. Bypass communication controller 122 functions by allowing computer system 110 to bypass, or otherwise circumvent, the default protocols preprogrammed within fuel controller 120. As has been discussed previously, the ability of computer system 110 to utilize bypass communication controller 122 rests in the ability of computing system 110 to generate and transmit a signal to fuel controller 120 that places it in an “interrupted state.” While operating within an interrupted state, fuel controller 120 ceases executing at least some of its default or preprogrammed functions instead relying on computer system 110 to dictate at least some of the operations.

In other embodiments, bypass communications controller 122 is connected to a storage device, such as data storage 140. In such scenarios, this connection is provided only to allow bypass communications controller 122 to access certain data at the command of computer system 110. For example, in some embodiments, computer system 110 provides content directly to bypass communications controller 122 that is then caused to be presented at fuel controller 130-1. However, in other embodiments, computer system 110 directs bypass communication controller 122 to retrieve or otherwise access the desired content from data storage 140 that is then caused to be displayed on fuel controller 130-1. In such embodiments, while bypass communications controller 122 can be connected to data storage 140, bypass communications controller 122 only communicates with the storage device at the behest of computer system 110 while fuel controller 120 is operating in an interrupted mode.

For the sake of completeness, in another embodiment, fuel controller 120 includes local storage 170. Within this local storage, various content elements and data are stored. For example, a library of pre-generated custom screen templates is stored within internal storage 170. In such embodiments, computer system 110 communicates with bypass communications controller 122 to provide an indication of a particular content element or data that should be retrieved from fuel controller internal storage 170. Bypass communications controller 122 then accesses internal storage 170 to retrieve the identified data and then causes the data to be transmitted to fuel dispenser 130-1 over communications channel 158.

In another embodiment, internal storage 170 is stored within fuel dispenser 130-1 instead of within fuel controller 120. In that embodiment, computer system 110 directs bypass communications controller 122 over communications channel 156 to retrieve the indicated content from local storage 170. However, because local storage 170 is now stored at fuel controller 130, bypass communications controller requests the identified data from fuel controller 130-1 over communications channel 158 and causes the data to be displayed at fuel controller 130-1. Thus, it should be appreciated that depending on the embodiment, content identified by computer system 110 for display at fuel controller 130-1 is retrieved from external storage, such as data storage 140, storage contained directly within computer device 110, storage contained directly within fuel controller 120, or storage contained directly within fuel dispenser 130-1.

### Generating Custom Interfaces

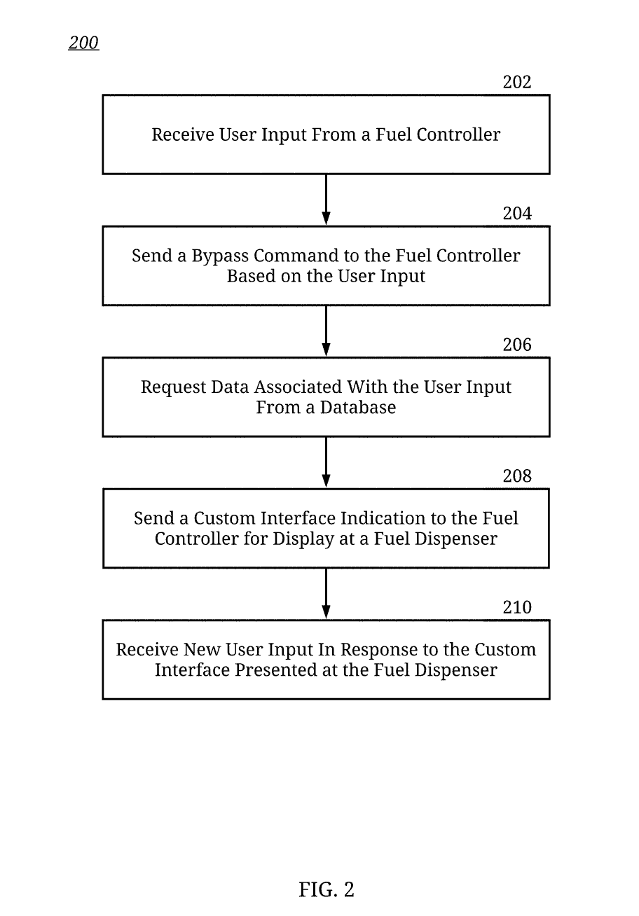

Moving now to FIG. 2, a method for generating custom interfaces at a fuel dispenser is shown. The individual steps of the method 200, according to various embodiments, will be explained, making frequent reference to the components illustrated in FIG. 1a and FIG. 1b.

In some embodiments, the method 200 begins with Step 202 including a computer system, such as computer system 110, receiving user input from a fuel controller, such as fuel controller 120. As has been discussed in conjunction with FIG. 1b, fuel controller 120 receives user input generated at a fuel dispenser such as fuel dispenser 130-1 when a user performs an action in response to a default screen prompt at fuel dispenser 130-1. In some embodiments, the received user input includes some form of a user identifier. In some embodiments, the user identifier is in the form of a credit card number, user name, account number, rewards number, fleet number, or some other identifier, for example.

In some embodiments, fuel controller 120 receives the user input over communications channel 150 and processes the user input at default communications controller 124. Computing system 110 then receives the user input from fuel controller 120 over communications channel 152.

Upon computer system 110 receiving the user input, a determination is made by computer system 110 concerning the user input. For example, in some embodiments, computer system 110 queries data storage 140 comparing the user input against records stored within data storage 140, for example at storage device 140-1. In some embodiments, upon matching the user input to a record or other data within storage device 140-1, computer system 110 then proceeds to execute Step 204 by sending a bypass command to the fuel controller 120. It should be noted, that in some embodiments, computer system 110 does not query storage device 140-1 or potentially any other storage, but instead simply proceeds to Step 204 as the result of receiving the user input from fuel controller 120.

At Step 204, computer system 110 sends a bypass command to fuel controller 120 based on the received user input. Again, as discussed above, in some embodiments, sending the bypass command occurs as the result of matching the user input to known or stored data. In other embodiments, sending the bypass command results based on the type, or a characteristic, of the user input received and identified by computer system 110 without an external query (e.g., the user input is a user name, account number, rewards number, fleet account identifier, etc.) In other embodiments, the bypass command is sent based on the manner in which the user input was generated by the user (e.g., at a magnetic card reader input, a near-field chip (NFC) receiver input, an EMV receiver input, a radio frequency identifier (RFID) input, a wireless data receiver input, a keypad input, or the like.) In yet other embodiments, computer system 110 sends a bypass command based on a combination of some or all of a comparison to known data, the type of user input received, and/or the manner in which the user input was generated.

In should be noted that the precise trigger that causes computer system 110 to generate and send the bypass command to fuel controller 120 varies based on other configuration characteristics of system 100.

Computer system 110 sends the bypass command to fuel controller 120 in a manner that causes fuel controller 120 to transition from the uninterrupted state into an interrupted state. In some embodiments, the bypass command is received by fuel controller 120 at default communications controller 124 by means of communications channel 152. In other embodiments, the bypass command is received by bypass communications controller 122 over communications channel 156. It should be appreciated that the exact manner and communications path the bypass command utilizes to place the fuel controller 120 into the interrupted state is dependent on the configuration of fuel controller 120 and different embodiments implement the bypass sequence differently. However, for the sake of simplicity, the example embodiments described with respect to the discussion relating to FIG. 2 utilize communications channel 152 to transmit the bypass command to fuel controller 120.

In some embodiments, the bypass command is sent by computer system 110 according to an application programming interface (API) operating at the fuel controller 120. For example, in some embodiments, computer system 110 communicates an API call to fuel controller 120 to cause fuel controller 120 to enter the interrupted state. An exemplary set of related API calls are included below as table 1. It should be appreciated that in embodiments using API calls to initiate the interrupted state in fuel controller 120, any suitable API call configuration or implementation is contemplated so long as the result is to place the fuel controller 120 into an interrupted state according to the disclosure provided within this specification.

In TABLE 1 shown below, the exemplary code sample will bypass a fuel controller's logic when a computer system, such as computer system 110, has determined that a bypass procedure is necessary in order to control an aspect or aspects of a transaction that the fuel controller would be incapable of completing without such a bypass and subsequent transaction control.

```
TABLE 1
// Open a window (BYPASS) message with the DPT (Fuel Controller);
′O′ value indicates opening the bypass window
wRec.Set(gReaderNum, pump_num, m_nLang, ′O′, ″PPYW″, false);
if (gMailMsg.SendReceiveWindow(wRec, &winResp) != SUCCESS)
{
    logger.Msg(sTran, 1, ″PrepayReceiptCntl: error
    sending/receiving PPYW window msg!″); // Log an error
    ResetPrepayRcpt( );
    return FAILURE;
}
// Build the print receipt prompt message for the fuel controller
BuildMsg(&Msg, “RCT?”);
// Send msg to Display the Print Receipt prompt at the fuel controller and
await timeout or answer
if (gMailMsg.SendCmd(&Msg) != SUCCESS)
{
    logger.Msg(sTran, 1, ″PrepayReceiptCntl: error sending %s
    command!″, Msg.CmdRec.szCmd); // Log an error
    ResetPrepayRcpt( );
    return FAILURE;
}
// Wait for a response from the fuel controller or time out if necessary
is_timeout = false;
status = SUCCESS;
while(!is_timeout)
{
    // Attempt to receive fuel controller response or get the timeout flag
    iRt = gMailMsg.ReceiveCmd(Msg.CmdRec.szCmd, response,
    sizeof(response) − 1, m_nLang, pump_num);
    if (iRt == SUCCESS)
    {
        logger.Msg(sTran, 1, ″PrepayReceiptCntl: %s success
        response, cnt <%d>″, Msg.CmdRec.szCmd, cnt); // Log
        success
        break;
    }
    else if (iRt != CANCEL)
    {
        logger.Msg(sTran, 1, ″PrepayReceiptCntl: error
        receiving %s response, could be timeout!″,
        Msg.CmdRec.szCmd); // Log an error
        status = FAILURE;
        break;
    }
}
// Check if response from fuel controller timed out
if(is_timeout)
status = FAILURE;
// FAILURE status, close the fuel control BYPASS window
If(status != FAILURE)
{
    // If Y is selected, display printing receipt msg, build
    receipt, and print the receipt.
    if (response[0] == ′Y′)
    {
        // Log customer response indicating print a receipt
        logger.Msg(sTran, 1, ″PrepayReceiptCntl: customer
        selected <YES FOR PRINT PREPAY RECEIPT>″);
        print_prepay_rcpt = ′Y′;
    }
    else
    {
        // Log customer response indicating do not print receipt
        logger.Msg(sTran, 1, ″PrepayReceiptCntl: customer
        selected <NO FOR PRINT PREPAY RECEIPT>″);
        print_prepay_rcpt = ′N′;
    }
    // Build and print the receipt through the fuel controller if customer
    wants a receipt
    if(print_prepay_rcpt == ‘Y’)
        BuildAndPrintReceipt( );
}
// Send close window (BYPASS) message to the fuel controller; ‘C’
value indicates to close the bypass window
wRec.Set(gReaderNum, pump_num, m_nLang, ′C′, 24, 10, ″PPYW″,
false);
if (gMailMsg.SendReceiveWindow(wRec, &winResp) != SUCCESS)
{
    logger.Msg(sTran, 1, ″SendPrepayPrintReceipt: error
    sending/receiving close window msg!″); // Log an error
    return FAILURE;
}
```

As shown above in TABLE 1, in some embodiments, upon computer system 110 communicating a command to “Open Window (BYPASS) Message” at fuel controller 120, an initial bypass or interruption operation occurs at fuel controller 120 resulting in fuel controller 120 entering the interrupted state. Likewise, upon completion of the portion of the transaction requiring interruption, computer system 110 communicates a “Close Window (BYPASS) Message) to fuel controller 120 that causes the interruption to cease resulting in fuel controller 120 returning to the default state. It is also appreciated that while additional API calls have been illustrated within TABLE 1, additional or alternative API calls are also contemplated allowing for broad interaction between computer system 110 and fuel controller 120.

In addition to sending the bypass command at Step 204, Step 206 includes computer system 110 requesting data associated with the received user input from a database. As has been discussed previously, in some embodiments, computer system 110 is attached to data storage 140 and queries against data storage 140 such as by querying storage device 140-1. It should be appreciated that depending on the embodiment, Step 206 is performed prior to Step 204, at effectively the same time as Step 204, or is performed after Step 204. For example, as was discussed above regarding Step 204, in some embodiments, computing system 110 determines whether to send the bypass command to fuel controller 120 by initially comparing the user input to data within data storage 140. Thus, in some embodiments, Step 206 is performed at the same time as Step 204 in order to, for example, reduce the number of calls to data storage 140, to reduce latency in the system, or various other reasons.

In other embodiments, Step 206 is executed subsequent to computer system 110 sending the bypass command to fuel controller 120. This may be desirable if, for instance, computer system 110 is configured to query different individual storage devices for the data used in Step 204 versus the data used in Step 206.

Regardless of the relative timing of Steps 204 and 206, upon receiving data associated with the user input at Step 206, computer system 110 executes Step 208 by sending a custom interface indication to fuel controller 120 for display at a fuel dispenser, such as fuel dispenser 130-1.

In some embodiments, the custom interface indication includes all of the data or content that computer system 110 has determined should be displayed at fuel dispenser 130-1. However, as has been discussed previously, in some embodiments the indication includes a pointer or other reference to particular data or content that should be displayed. In such embodiments, the fuel controller 120 then utilizes the indication, pointer, reference, etc., to retrieve the content identified by computer system 110 for display at fuel dispenser 130-1. For example, computer system 110 includes a pointer to content stored at internal storage 170. In yet other embodiments, the indication provided by computer system 110 includes both a portion of the content or data to be displayed as well as a reference or pointer to additional content. For example, computer system provides loyalty information retrieved from external storage 140 along with a pointer to a display template stored at internal storage 170. Fuel controller 120 then incorporates the provided loyalty data along with the identified display template.

Because fuel controller 120 was placed into the interrupted state at Step 204 when computer system 101 sent the bypass command, in one exemplary embodiment, the custom interface indication sent in Step 208 is sent over communications channel 156 and received at fuel controller 120 by the bypass communication controller 122. The content associated with custom interface indication is then transmitted by fuel controller 120 to the particular fuel dispenser, such as fuel dispenser 130-1 over communication channel 158.

In some embodiments, the content of the custom user interface sent by computer system 110 is received in its entirety from a remote data store, such as from storage device 140-1. In other embodiments, computer system 110 generates portions of the custom user interface directly and integrates other portions of content received from the remote storage. For example, in some embodiments, the custom user interface includes the user's name along with a personalized message. As an example, the initial user input received at Step 202 may have included an account number. Upon receiving the account number, computer system 110 derives the user's name associated with the account number by querying against data storage 140 and matching a record associated with the account number. In some embodiments, computer system 110 then generates the custom user interface by integrating the derived user name along with other content desired to be sent in association with the user name.

In other embodiments, during the same query to data storage 140 made in conjunction with Step 202, the data storage 140 includes additional information for display at the fuel dispenser beyond the user name. For example, in some embodiments, data storage 140 includes customized user interface templates that are merged other information associated with the user input to generate a complete custom user interface. This custom user interface is then received by computer system 110 from data storage 140 and then transmitted to fuel controller 120 for eventual display at a fuel dispenser. Thus, it should be appreciated, that the exact manner of generating the custom interface is dependent upon the embodiment but that, no matter the configuration, the custom interface is eventually transmitted from computer system 110 to fuel controller 120 while fuel controller 120 is in the interrupted state initiated upon receipt of the bypass command.

As a result of executing Step 208, the custom interface transmitted by computer system 110 to fuel controller 122 is displayed at a fuel dispenser, such as fuel dispenser 130-1. In some embodiments, the custom interface includes a promotional offer or a recommendation, according to the association criteria discussed previously in conjunction with generating the custom interface. For example, based on deriving the identity of the user of the fuel dispenser based on the originally provided user input, the custom interface includes a promotional offer created specifically for the user based on information known about the user, such as previous transactions by the user stored at data storage 140.

In embodiments implementing a promotional offer, the promotion may include discounts or other offers relating to the fueling transaction such as, for example, a discount based on a particular fuel type (e.g., 100 off premium gasoline.) Such a promotion may be linked to a transaction stored at data storage 140 that associates the user with prior transactions that included premium fuel when the fuel price was below a particular threshold. Further, in some embodiments, the level of the promotional offer is linked to what is known about the user. For example, a promotional offer may increase or decrease based on a known or predicted threshold for a purchasing decision by the user based on prior transactions or other knowledge about the user or other users.

In other embodiments, the promotional offer includes an offer for a product or service other than the fueling transaction. For example, the custom interface includes a promotional offer for coffee sold inside the fueling station building. Again, this exemplary embodiment links prior transactions or other known information about the user to generate the custom interface that includes the promotional offer. For example, data storage 140 may include various transaction records associated with the user indicating that when the user visits the fueling station during morning hours, the user sometimes purchases coffee. By offering a promotion relating to the prior purchasing habits of the user while the user is still at the fueling dispenser, a user may be more likely to purchase more than just fuel during the transaction.

In other embodiments, a recommendation is included in the custom interface instead of or in addition to the promotional offer described above. In the case of a recommendation, the custom interface may include a notification that the user try a new product or service at the fueling station. Such a recommendation need not include a discount or coupon, but rather is simply derived based on information known about the user such that the recommendation is targeted to the user.

In other embodiments, the custom interface provides functional information necessary for the fueling transaction to continue to progress. For example, in some embodiments a user at a fuel dispenser, such as dispenser 130-1, provides a fleet account number during Step 202. Based on determining that the user is a fleet user, computer system 110 generates a custom interface to send to interrupted fuel controller 120 that includes interface elements relevant to the particular fleet user.

Custom Configurations for Multiple Products Transactions with Selective Sequencing

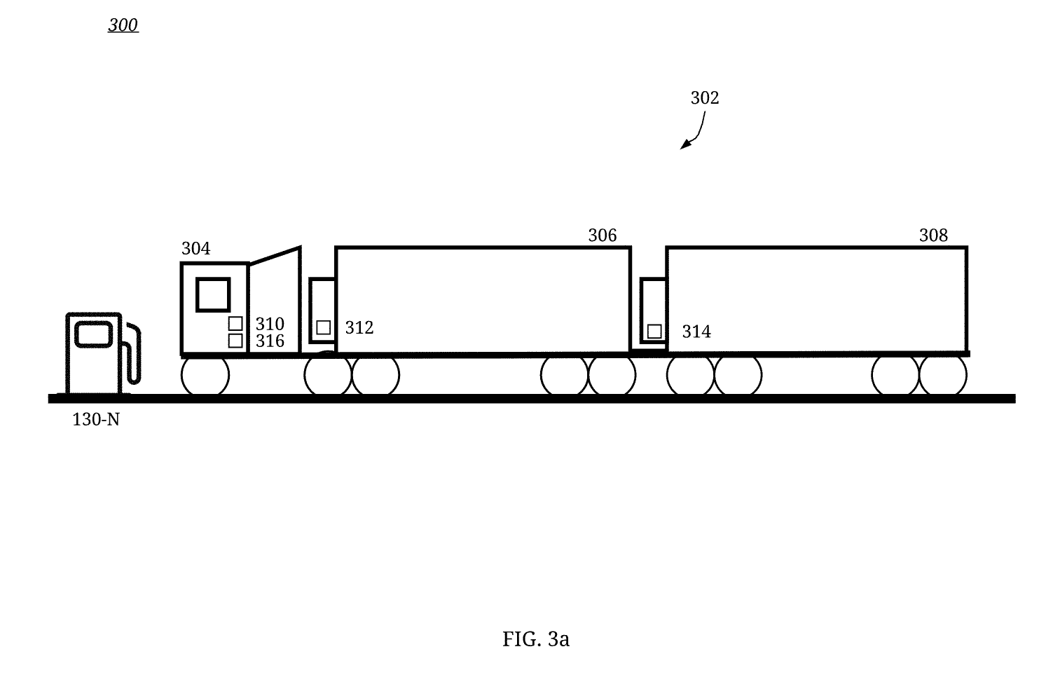

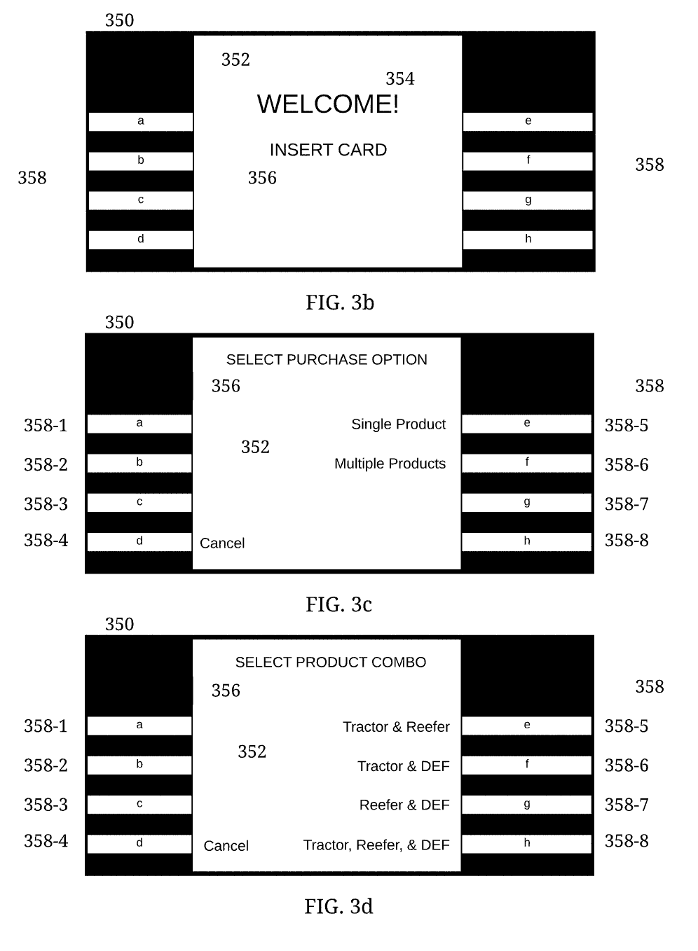

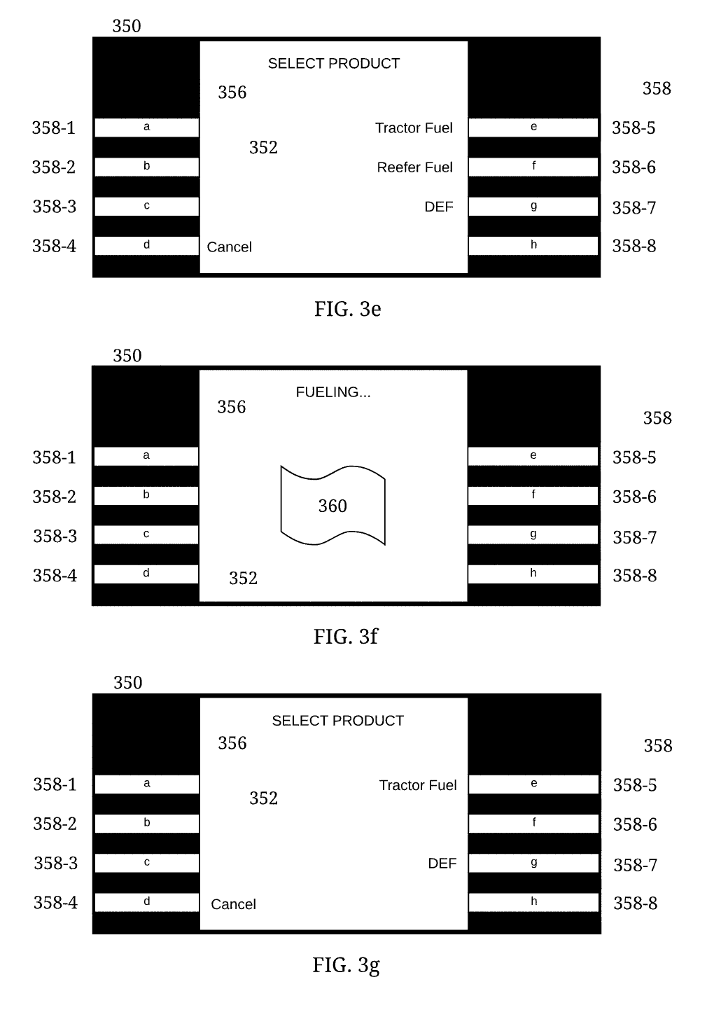

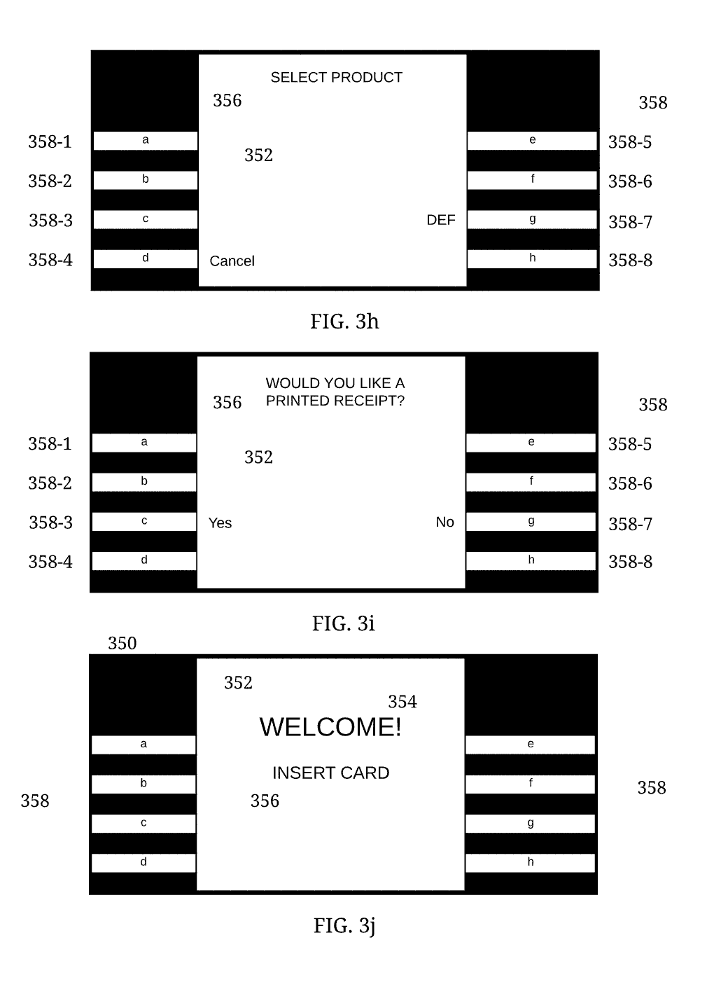

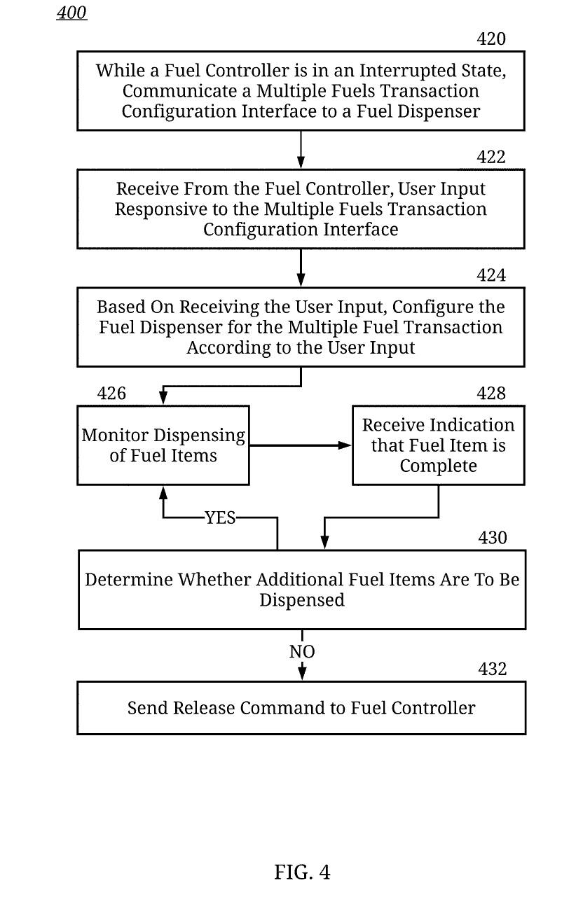

Transitioning now to FIGS. 3a through 3j and FIG. 4, functional diagrams and a method for utilizing the custom interface to configure and execute multiple products transactions are illustrated.

An improved multiple products transaction configuration system is described herein. In one embodiment, a fueling transaction requires more than two different types of products be dispensed. For example, in some embodiments, three or more products need to be dispensed. Additionally, due to the physical configuration of some multiple-fuel vehicles, it is desirable not only to enable the selection of multiple products in a single transaction, but also to enable customization of the dispensing sequence of the multiple products.

Pre-set, non-customized systems have various limitations. For example, in order to represent all of the various permutations that include two or three fuels, a system with only pre-set fueling options would need to display twelve different options to the user in order to ensure that all possible options were available to a user. For example, for fuels “A,” “B,” and “C,” the various permutations required for dispensing at least two fuels in every possible sequence would be AB; BA; BC; CB; AC; CA; ABC; ACB; BAC; BCA; CAB; CBA. As can be appreciated, if a preset fueling system were to present such a screen, the screen would be very complex and likely lead to user error and confusion. Of course, this complexity is exponentially increased with the introduction of each additional fuel type in the transaction.

As described herein, fuel dispensers are capable of dispensing a wide variety of products. For example, a fuel dispenser may dispense various fuels recommended for various types of internal combustion engines such as diesel fuel, unleaded fuel, ethanol free fuel, or the like. Additionally, some fuel dispensers may also be capable of dispensing non-fuel products such as fuel additives, detergents, cleaners, or other non-fuel products used to augment other fuels. In some locations within this description, fuel dispensers will be described as dispensing a particular “fuel” or “product.” Unless otherwise identified, it should be appreciated that this invention encompasses the dispensing of both fuels and other non-fuel products.

The customization of the dispensing sequence for multiple fuels or products is contemplated in this application is thus an important practical improvement over typical pre-set sequence multiple-product systems.

As illustrated in FIG. 3a, a fueling system 300, including a vehicle 302, and a fuel dispenser 130-N, is contemplated. In such an embodiment, the tractor 304 is located at the front of the vehicle 302 and operates to pull the two semi-trailers 306 and 308 in tandem behind the tractor 304. It should be appreciated that in such double tractor-trailer situations, the overall length of the tractor and double semi-trailers 302 is often 65 feet or more “tip to tail.” In this exemplary embodiment, a diesel engine of the tractor 304 is located nearest the front end of vehicle 302 and requires a particular type of fuel and may require additional non-fuel additives. Next, each of the two semi-trailers 306 and 308 includes a refrigeration unit 312 and 314, respectively. Because of this, the fueling location 312 for the first semi-trailer is behind the fueling location 310 for the tractor 304, but in front of the fueling location for the refrigeration unit 314 of the second semi-trailer 308.

Due to the overall size of the tractor and trailers, that can cause the first semi-trailer 306 fueling location 312 to be far enough behind the fueling location 310 of the tractor 304 that the vehicle 302 must be moved forward in order to utilize the fuel dispenser 130-N at the fueling location. Likewise, the fueling location 314 for the second refrigeration unit 308 is even farther to the rear, possibly requiring a second relocation of the vehicle 302 in order to fuel the second semi-trailer 308.

It is also contemplated that, in some embodiments, all three components (e.g., the tractor 304 and each of the two semi-trailers 306 and 308) require a different type or grade of fuel to be dispensed. Thus, the sequence of dispensing the required fuel becomes important. System 100 enables a driver to choose to fuel in sequence from the front to the rear of the vehicle (e.g., fueling at location 310, then 312, then 314) or other sequences selected by the fueling truck driver. This sequence selection enabled by system 100 is often preferable over a typical pre-programmed, non-selective sequence.

It is also appreciated that the present invention contemplates a selective sequence that includes more than a three-fuel sequence. For example, in some embodiments a driver selects more than three different types of fuels is enabled to sequence them in a selected order that allows fueling at more than three different physical locations on the vehicle. The selective fuel sequencing of the present invention enables a fueling user to pick the sequence that fuel is dispensed—a major advantage that solves problems caused by non-selective preprogrammed sequences.

Thus, in some embodiments, the custom interface transmitted by computer system 110 includes interface components to execute a multiple products transaction. For example, the sequence-selective custom interface includes the ability for a user to select the first fuel type and the second fuel type (and then, in some embodiments, a third, fourth, or Nth product type) according to the sequence the user determines is the desirable fueling sequence.

Returning to the method 200, irrespective of the content of the custom user interface (e.g., a promotion, a recommendation, a multiple products transaction, or any other custom interface content), Step 210 includes receiving, at computer system 110, a new user input that was generated in response to the custom interface presented at the fuel dispenser. For example, in some embodiments, the new user input includes an acceptance of a promotional offer to receive a good or service from inside the fueling station building (e.g., coffee, food, a shower, etc.)

In an embodiment where the custom interface includes content enabling a multiple products transaction, the new user input includes the selected fuels and sequence as determined by the user.

It should be noted that the new user input is received while the fuel dispenser 120 is still in the interrupted state. Thus, consistent with the exemplary embodiments described herein, the new user input is received at the fuel controller 120 from fuel dispenser 130-1 over communication channel 158 such that it is received by bypass communication controller 122. Computer system 110 then receives the new user input from fuel controller 120 by the bypass communication controller 122 transmitting the new user input to computer system 110 over communications channel 156.

In some embodiments, based on receiving the new user input, Steps 202 through 210 of method 200 repeat for any number of additional cycles. For example, a new offer or recommendation is generated based on the user information and a new custom user interface is generated for display at the fuel dispenser 130-1. It should be appreciated, however, that in embodiments where multiple cycles and multiple custom interfaces are created and sent, that at least Step 204 need not be repeated as fuel controller 120 remains in the interrupted state unless or until computer system 110 communicates a release command to fuel controller 120.

For example, once computer system has determined that the portions of the fueling transaction that require the display of custom user interfaces has completed, computer system 110 then communicates a release command to fuel controller 120 that places fuel controller 120 back into the uninterrupted state. For example, upon execution of Step 210, computer system 110 communicates a release command to fuel controller 122. In some embodiments, the release command is transmitted from computer system 110 to fuel controller 120 over communication channel 156 such that it is received by bypass communication controller 122. However, once a release command is received, fuel controller 120 is place back into the uninterrupted state. Consequently, future communication between fuel controller 120 and fuel dispenser 130-1 again occurs over communication channel 150 instead of communication channel 158. Similarly, communication between fuel controller 120 and computer system 110 occurs utilizing default communication controller 124 and communication channel 152 rather than bypass communication controller 122 over communication channel 156.

In some embodiments, once fuel controller 120 is placed back into the uninterrupted state, default actions are then resumed such as providing the user a receipt according to a preconfigured action within the fuel controller 120. Further, once the particular fueling transaction has been complete, fuel controller 120 then execute the default operation to cause a default screen to be presented at fuel controller 130-1 in preparation for the next transaction.

As has been shown above, a multiple products transaction can be implemented using the method 200 illustrated in FIG. 2. However, in order to more fully describe some aspects of multiple products transactions, a sequence of display screen examples is provided in FIGS. 3b through 3j. Additionally, a method 400 shown in FIG. 4 will be described in conjunction with FIGS. 3a through 3j along with the previously discussed system 100 as shown in FIGS. 1a and 1b.

In FIG. 3b, a multiple products transaction configuration unit 350 is shown. In some embodiments, unit 350 is fully integrated within a fuel dispenser, such as fuel dispenser 130-1, for example, as the main display of fuel dispenser 130-1. While other embodiments are contemplated, such as configuration unit 350 being configured for display on a user's mobile device, in-vehicle infotainment system, or other non-fuel dispenser configuration, for the sake of simplicity, it will be assumed that configuration unit 350 is integrated directly within a fuel dispenser.

Configuration unit 350 includes main screen area 352, default message 354, instruction message 356, and input controls 358 (labeled twice to reflect that input controls “a” through “h” are referenced singularly as examples of input controls 358.)

It is appreciated that the precise location of default message 354 and instruction message 356 within screen 352 is not limited to the locations shown in the figures but, rather, is dependent upon the configuration of the display and the types of messages that need to be displayed. It is also appreciated that the classifications of “default” and “instruction” are arbitrary and merely meant to illustrate one potential use of each of the messages. As such, depending on the embodiment, messages of any type can be shown within message area 354 and 356.

It should also be appreciated that screen area 352 is implemented using any suitable digital display such as a LCD display, TFT display, CRT display, electronic ink display, or the like. It should also be appreciated that in some embodiments input controls 358 are “soft keys” provided as touch inputs on screen area 352. For example, in some embodiments, screen area 352 includes a touch screen of any suitable technology (e.g., a capacitive, resistive, piezoelectric, and/or infrared touch screen) that allows direct user selection of options represented by controls 358. In other embodiments, input controls 358 are “hard keys” provided around screen area 352 but implemented as physical buttons configured to dynamically select options according to what is displayed in screen area 352. In other embodiments, a combination of hard and soft keys is provided. Regardless of the implementation of input controls 358, a user can effectuate the selection of an option by pressing the particular area or button corresponding with the desired input control to cause configuration unit 350 to recognize a corresponding selection.

It is also appreciated that FIG. 3b represents one example of a default interface presented at fuel dispenser 130-1 as dictated by fuel controller 120 while fuel controller 120 is in a default or uninterrupted state. In other words, in some embodiments, FIG. 3b is communicated to fuel dispenser 130-1 from default communication controller 124 of fuel controller 120 over communication channel 150. As has been discussed previously, in some embodiments fuel controller 120 directly provides all of the data and/or content necessary to render the material shown on screen 352 while in other embodiments fuel controller 120 provides an indication for fuel dispenser 130-1 to retrieve the contents of screen 352 for display. Regardless of the embodiment, fuel controller 120 operates in an uninterrupted mode to cause screen 352 of FIG. 3b to be generated.

As the example illustrates, FIG. 3b represents a default “Welcome” screen that is displayed at a fuel dispenser when a customer initially begins a fueling transaction. While message 354 includes the text “Welcome,” it is appreciated that message 354 can include any message for a user that the operator of fuel dispenser 130-1 wants to initially display. For example, message 354 could alternatively or additionally include a logo, branding, slogan, or the like. In other embodiments, message 354 includes media such as a video, picture, sound, or the like. In some embodiments, a combination of textual, graphical, or aural content is displayed in conjunction with message 354. Similarly, message 356 is shown as an instruction to the user to “Insert Card.” It is appreciated that message 356 can also include various types of information.

However, while screen 352, message 354, and message 356 may be configured with various display and content parameters, it must be appreciated that because FIG. 3b represents an interface generated while fuel controller 120 is operating in an uninterrupted state, the screen is unable to be customized according to the user or any other transaction specific parameter. Rather, the default screen is presented without any understanding of the user and is presented as a default initial screen.

With reference to FIG. 3b, in this exemplary embodiment, upon following the instruction message 356, assume for example that the user inserts a fleet card that includes a fleet card identifier. Upon insertion of the card, computer system 110 receives an indication (e.g., as discussed in conjunction with Step 202 of FIG. 2) that includes the fleet identifier. Computer system 110 then places fuel controller 120 into the interrupted state. In some embodiments, the interrupted state is initiated in a manner consistent with the examples provided previously in conjunction with FIG. 1b and FIG. 2. In other embodiments, the interrupted state is initiated by other suitable means.

For example, by inserting a payment card in response to the screen 352 presented in FIG. 3b, computing system 110 may have received an indication that the card included a fleet identifier. In such an embodiment, upon recognizing that the payment card was a fleet card, computer system 110 communicates a bypass command to fuel controller 120 placing fuel controller 120 in an interrupted state.

However, with regard to FIG. 4, regardless of the manner that caused the fuel controller to enter the interrupted state, Step 420 includes communicating a multiple products transaction configuration interface to a fuel dispenser, such as fuel dispenser 130-1. Now that the fuel controller 120 has been placed into the interrupted state, the method 400 can begin at step 420 by computer system 110 communicating a multiple products transaction configuration interface to fuel dispenser 120.

FIG. 3c illustrates an exemplary screen generated as a result of Step 420. As illustrated, the user is presented with a set of initial configuration parameters. In the embodiment of FIG. 3c, a user is presented with various options such as “Single Product” associated with key 358-5 and “Multiple Products” associated with key 358-6. In some embodiments, additional or different options are presented at the same or different keys 358-1 through 358-8. Importantly, the options presented in screen 352 of FIG. 3c are generated, at least in part, by computer system 110 recognizing information specifically tied to the user input that caused fuel controller 120 to be placed into the interrupted state. For example, in this embodiment, computer system 110 placed fuel controller 120 into the interrupted state because it was recognized that the fleet card inserted at the fuel dispenser qualified for a multiple products transaction. As such, FIG. 3c was presented in a manner that was customized for the particular user based on the use of the fleet card.

It should be appreciated that because fuel controller 120 is in an interrupted state, the transaction configuration interface in FIG. 3c is not generated by the fuel controller 120 but is instead generated by a separate computer system such as computer system 110. For example, as described previously, message 356 “select purchase option”, the “single product” option associated with key 358-5, the “Multiple Products” option associated with key 358-6, and the “Cancel” option associated with key 358-4 is caused to be displayed at fuel dispenser 130-1 by computer system 110. In some embodiments, computer system 110 generates the data on its own and transmits the data through fuel controller 120 for display at fuel dispenser 130-1. In other embodiments, the particular configuration desired for the screen in FIG. 3c is preconfigured and stored separately from computer system 110 but in a manner that still allows computer system 110 to cause fuel controller 120 to access the screen to display the information at fuel dispenser 1301.

Next, according to Step 422, user input responsive to the interface of FIG. 3c is received at computer system 110 from the fuel dispenser 130-1. Although the fuel controller 120 is in an interrupted state, the input received from fuel dispenser 130-1 is received through fuel controller 120 such as over communication channels 158 and 156 in conjunction with bypass communication controller 122. In this example, computer system 110 receives an input indicating that the user has selected the “Multiple Products” option associated with key 358-6.

At step 424, based on receiving the user input selecting key 358-6, computer system 110 configures fuel dispenser 130-1 for a multiple fuel transaction according to the user input. For example, computer system 110 transmits the custom user interface of FIG. 3d to fuel dispenser 130-1 by means of fuel controller 120 over communications channels 156 and 158 in conjunction with bypass communication controller 122. Additionally, the custom user interface is configured to provide prompts or other content to aid the user of fuel dispenser 130-1 in dispensing the multiple fuels. For example, in FIG. 3d, various combinations of fuel types are presented. Key 358-5 includes an option for “Tractor & Reefer” fuel, key 358-6 includes an option for “Tractor & DEF” fuel, key 358-7 includes “Reefer & DEF,” and key 358-8 includes “Tractor, Reefer, & DEF.” It should be appreciated that the particular types of fuels displayed are not crucial to the invention. Rather, it is appreciated that the ability to select various combinations of different fuels is enabled. Continuing with this exemplary embodiment, the user selects key 358-8 to initiate the option to fuel tractor, reefer, and DEF fuels. Additionally, for the sake of clarity, “tractor” fuel is fuel designed to be used by the main engine of a tractor, “reefer” fuel is a term of art for fuel used in refrigeration units such as those used in semi-trailers, and “DEF” is a term of art for “diesel exhaust fluid” that is used as an additive to but that pumped separately from normal diesel tractor fuel.

In response to the screen of FIG. 3d being presented at step 424, the user of fuel dispenser 130-1 is next presented with the screen 352 shown in FIG. 3e. Within this exemplary embodiment, it is additionally assumed that the user selects key 358-8 on screen 352 of FIG. 3d, indicating that the user wants to pump “Tractor, Reefer, and DEF” during the multiple products transaction.

Upon selecting key 358-8 of FIG. 3d, fuel dispenser 130-1 transmits the selection to fuel controller 120. Because fuel controller 120 is in an interrupted state, fuel controller 120 then simply passes the selection on to computer system 110. Upon receiving the user input selecting key 358-8, computer system 110 then causes a new custom user interface, illustrated as FIG. 3e, to be presented at fuel dispenser 130-1.

As illustrated, FIG. 3e individually presents each of the three fuel types selected on the prior screen corresponding to keys 358-5, 358-6, and 358-7. Additionally, the “Cancel” operation remains in operation at key 358-4. The user presented with the screen shown in FIG. 3e now has the ability to select any of the three available fuels for dispensing. It should be appreciated that because any of the three fuels can be selected at this point in the sequence, the user can customize the fueling order to whatever sequence they prefer (e.g., such as from front to rear of vehicle 302 as discussed in conjunction with FIG. 3a)—a process referred to herein as “selective sequencing,” and that is highly advantageous to a user engaged in a fueling transaction.

It is assumed for this example that the user first selects key 358-6 to dispense “Reefer Fuel.” As a result of making a fueling selection the screen is transitioned from FIG. 3e to FIG. 3f.

Returning back to method 400, at Step 426, while fuel dispenser 130-1 dispenses the reefer fuel selected in FIG. 3e, the fuel dispenser 130-1 communicates various progress updates to fuel controller 120. For instance, fuel dispenser 130-1 continually updates fuel controller 120 as to the amount of fuel that has been dispensed, the status of the fueling nozzle (e.g., whether it has been rehung on the dispenser indicated the end of that portion of the fueling transaction.)

In some embodiments, such communications occur across communication channel 158 in conjunction with bypass communications controller 122 because fuel controller 120 has been placed in the interrupted state. In some embodiments, fuel controller 120 transmits these updates over communications channel 156 to computer system 110. In other embodiments, fuel controller 120 is able to manage such status messages from fuel controller 130-1 on its own even though it is in the interrupted state.

During this time, screen 352 of configuration unit 350 displays a progress type screen as illustrated in FIG. 3f For example, message 356 includes an indication that the fuel dispenser 130-1 is “Fueling . . . ” Likewise, as illustrated by element 360, additional content is shown on the screen. Because this is a custom user interface generated by computer system 110, in some embodiments, element 360 includes content specifically tailored to the user. For example, an advertisement or promotion directly tied to the user is presented. In other embodiments, video, graphical elements, text, or other visual information tailored for the user is presented. Finally, while customized content is presented in some embodiments, in some embodiments generic or non-custom information is also or alternatively shown.

Regardless of whether fuel controller 120 has retained some autonomy in the automated state in order to process intermediate status updates, at Step 428 computer system 110 receives an indication that the current fuel item being dispensed has completed. As indicated above, in some embodiments this indication occurs by the user of fuel dispenser 130-1 placing the nozzle of the fueling dispenser back into its receptacle. In other embodiments, the user of fuel dispenser 130-1 provides an indication in response to the custom user interface (e.g., selects an option on the custom user interface indicating that the user is done with the fuel type.)

Next, at Step 430, computer system 110 determines whether additional fuel items are to be dispensed. Computer system 110 is able to do this based on the input received from the user at Step 422 that provided the desired dispensing configuration (e.g., fuel types and sequence.) If at Step 430 computer system 110 determines that additional fuels are to be dispensed based on the received configuration information, computer system 110 again executes the sequence of Steps 426, 428, and 430.

For example, after receiving the indication that the user has finished fueling the “reefer” fuel, computer system 110 causes configuration unit 350 to display the screen illustrated in FIG. 3g. It is noted that FIG. 3g is identical to FIG. 3e except that the “reefer” option has now been removed since the user has finished that portion of the multiple products transaction.

In this example, the user next selects key 358-5 indicating a desire to dispense “Tractor Fuel” next. As a result, computer system 130-1 receives an indication that the user has selected the next fueling product and causes configuration unit 350 to display a screen 352 like the one described in FIG. 3f It should be appreciated that while a fueling status type screen, such as FIG. 3f, is shown between each fueling operation in a multiple fuels operation, each such screen need not be the same.

As with the first fuel type, as the user dispenses the tractor fuel, computer system 100 executes Step 426 to monitor the dispensing of the second fuel. Eventually, computer system 110 receives an indication, at Step 428, that the second fuel has been dispensed. Again, this indication comes in the form of the user returning the fueling nozzle to the fuel dispenser, selecting a key on configuration unit 350, or the like.

Computer system 110 again executes Step 430 and determines whether additional fueling items remain. As is the case in this example, computer system 110 determines that additional fuels need to be dispensed and, as a result, causes fuel dispenser 130-1 to present screen 352 as illustrated in FIG. 3h.

As can be appreciated, the cycle described above in conjunction with dispensing the reefer fuel and then the tractor fuel is repeated.

Eventually, once all fuels have been dispensed, computer system 110 determines at Step 430 that all fuel items have been dispensed. At that point, computer system 110 communicates a release command to fuel dispenser 120 as, for example, described in conjunction with FIG. 1b and FIG. 2.

Once fuel controller 120 has been placed back into the uninterrupted state, it can then perform pre-programmed processes in order to complete functions such as generating a receipt and displaying a default user interface as illustrated by FIG. 3j. It is appreciated that FIG. 3j illustrates a configuration unit 350 with screen 352 contents that are identical to FIG. 3b that began this process.

It should also be appreciated that in the forgoing method 400, in some embodiments, the user exits the loop represented by Steps 426, 428, and 430 prior to completing all of the fuel dispensing operations initially requested in FIG. 3d. For example, in some embodiments the user selects key 358-4 to cause the “Cancel” operation to occur. For example, the user realizes that DEF fuel is not needed after all and chooses to cancel the transaction having only dispensed reefer and tractor fuel. In other embodiments, a user forgets or otherwise simply does not complete the fueling sequence. In such instances, the system implements a time-out procedure.

For example, if a user does not complete the next leg of the fueling sequence within 1 minute, 5 minutes, or some other time frame, computer system 110 recognizes the timeout as an indication that the transaction has completed and sends a resume command to fuel controller 120 to reset fuel dispenser 130-1 back to a default start configuration. In yet another embodiment, while computer system 110 is monitoring the fuel dispensing at Step 426 of method 400, the computer system 110 determines that the user has met a threshold amount of dispensed fuel. For example, a user is preauthorized for $100 worth of fuel, but reaches that threshold prior to the end of the fueling sequence. In such a scenario, the threshold value acts as the indication at Step 428 and computer system 110 then determines at Step 430 that no additional fuel is to be dispensed. In some embodiments, the threshold is for a total amount of dispensed fuel while in other embodiments thresholds are established for each cycle of the fueling transaction.

FIGS. 3c through 3i are examples of custom interfaces at a fuel dispenser that are dynamically displayed by bypassing a fuel controller and placing system 100 in an interrupted state to thereby enable customized selections by a user.

It should also be appreciated that while FIGS. 3b through 3j have been described above as being implemented with a configuration unit 350 embedded or otherwise linked to a fuel dispenser such as fuel dispenser 130-1, all of the screens along with their corresponding interactions and manipulations in conjunction with method 400 can also be implemented using devices and/or screens separate from fuel dispenser 130-1.

For example, in some embodiments, the screens represented by FIGS. 3b through 3j are generated on a mobile device such as a mobile phone, tablet, or digital display integrated within the vehicle that is fueling (e.g., a vehicle infotainment system.) In some embodiments that utilize an interface separate from the fuel dispenser, the process essentially functions in the same manner with the exception that computer system 110 causes the displays to be generated at the separate interface rather than (or in addition to) the fuel dispenser. In some embodiments, this is enabled by allowing fuel dispensers to communicate with external devices using a communications protocol such as Wi-Fi, Bluetooth, or other radio wave based communication protocol. In other embodiments, a user of the external device installs an app or software package on the device that allows the device to communicate with computer system 110. In some embodiments, the displays are still transmitted through fuel controller 120 while in other embodiments, computer system 110 provides separate communications to the external device for generating the displays.

Because of the selective sequencing enabled by the system 100 and the embodiments described with respect to FIG. 3a through FIG. 4, a user engaged in a fueling transaction with sequence of filling locations located along the length of an extended vehicle (e.g., a semi-truck, semi-trailer combination), such as shown in FIG. 3a, can dispense fuel at the various filling ports in a sequence that makes the most sense to the user. Numerous factors affect the sequencing decision including the length of the dispensing hose, the location of the fuel dispenser, the location of the fueling ports, and other parameters that affect the desired selective sequence.

### Leveraging Loyalty Information in Custom Screens

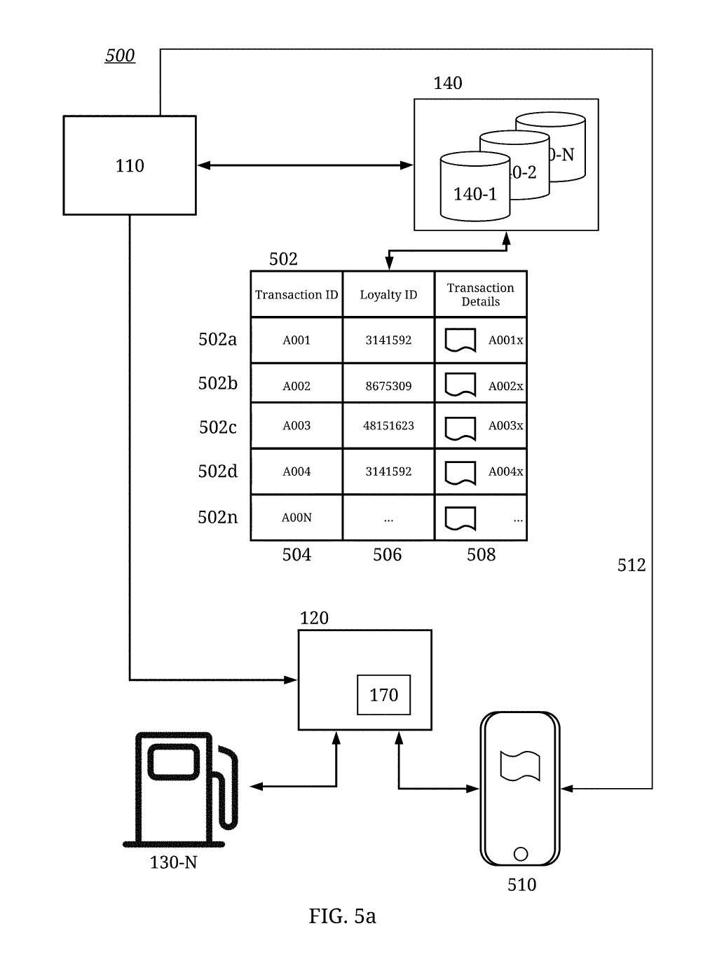

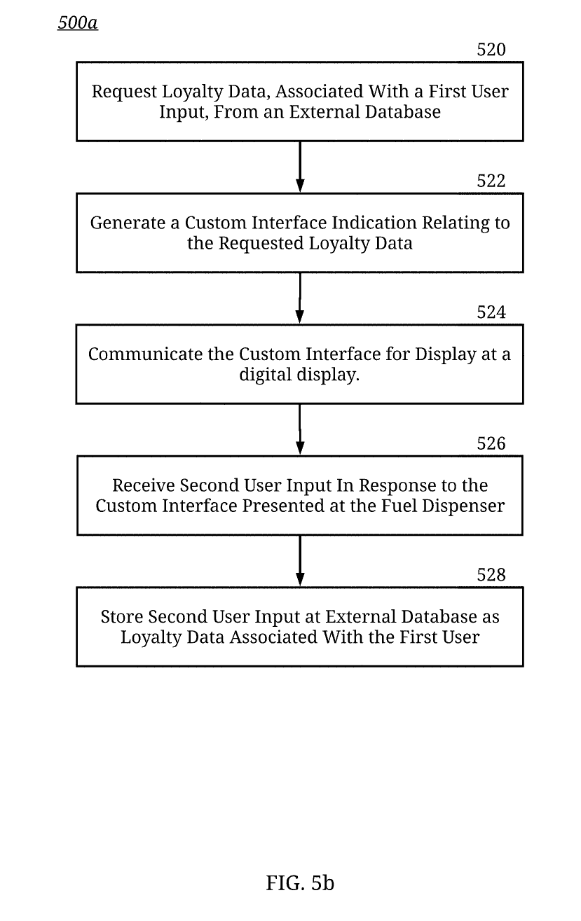

Turning now to FIGS. 5a and 5b, a system 500 and a method 500a, are shown, that allow for a computer system, such as computer system 110, to manipulate loyalty rewards information for storage, query, and utilization within custom user interfaces generated at a fuel dispenser, such as fuel dispenser 130-N.

In FIG. 5a, one embodiment of a system that utilizes loyalty information to generate custom promotional screens is shown. FIG. 5a illustrates a computer system 110, such as the computer system 110 shown in various other embodiments described herein. Likewise, data storage 140 including individual storage devices 140-1, 140-2, and 140-N are illustrated. As has been noted previously, in some embodiments, data storage 140 is a separate device from computer system 110 while in other embodiments data storage 140 is integrated within the same system as computer system 110, such as a RAID storage device stored within computer system 110. In other embodiments, data storage 140 is remote from computer system 110 and is accessible over a network. In such embodiments, data storage 140 may be a network attached storage device (NAS), storage area network (SAN) infrastructure, cloud storage, storage as a service, or another implementation of remotely connectable storage.

FIG. 3a also illustrates an example of a loyalty table 502. Within table 502, numerous exemplary records are illustrated including records 502a, 502b, 502c, 502d, and 502n. It is appreciated that table 502 can hold essentially any number of records as intended by the illustration of record 502n. Additionally, table 502 is illustrated as having three columns. Column 504 is identified as a “Transaction ID” column, 506 as a “Loyalty ID” column, and 508 as a “Transaction Details” column. It should be appreciated that these labels are arbitrary and table 502 is in no way limited to having only three columns. Instead, the illustrated column quantity and identifiers are meant only as examples for some embodiments.

Within column 504, a series of transaction IDs are illustrated corresponding to records 502a through 502n. In some embodiments, transaction IDs are unique identifiers within table 502 that allow a particular record to be identified and information associated with that record to be retrieved. For example, transaction ID “A001” associated with record 502a is associated with Loyalty ID “3141592” within column 506 and Transaction Details “A001x” within column 508. Likewise, transaction ID “A002” associated with record 502b is linked to Loyalty ID “8675309” and Transaction Details “A002x.” The same is true for records 502c through 502n.

It should also be noted that in some embodiments columns 504 through 508 contain different information or the same information but in different formats. For example, transaction IDs are shown as numerical data but in some embodiments they are alphanumerical or timestamps or another suitable identifier. Likewise, the transaction details content within the particular records is illustrated both with an identifier (e.g., “A001x”) as well as with a symbol. This is intended to represent that in some embodiments transaction details comprise storage blobs, attached documents (e.g., PDF receipts) or other complex information. In some embodiments, a combination of data types is used in order to enable effective querying of portions of data while still retaining rich data sets.

FIG. 5a also illustrates a fuel controller 120, such as fuel controller 120 illustrated in other embodiments described herein. Fuel controller 120 also includes internal storage 170. Finally, a fuel dispenser 130-1 and a mobile device 510 are also illustrated.

To better illustrate the system 500 of FIG. 5a, a method 500a is described below.

In this exemplary embodiment, at Step 520, computer system 110 requests loyalty data from data storage 140. The requested loyalty data is associated with a user input, such as a user input received at fuel dispenser 130-1 and transmitted through fuel controller 120 back to computer system 110 (e.g., in a manner consistent with other embodiments described here in such as with FIG. 1b.) For example, a user swipes their loyalty card in a magnetic card reader integrated within fuel dispenser 130-1 or types a loyalty number into a keypad integrated within fuel dispenser 130-1. Fuel dispenser 130-1 transmits the input to fuel controller 120 that then passes it to computer system 110. In some embodiments, computer system 110 then generates a bypass command and transmits it back to fuel controller 120 causing the controller to transition to the interrupted state.

Computer system 110 then requests the loyalty data from data storage 140 in accordance with Step 520. The query executed at Step 520 involves computer system 110 transmitting at least the user input received from fuel controller 120. In this example, assume that the user swiped a loyalty card at fuel dispenser 130-1 that included the user's loyalty account number “3141592.” That loyalty number is passed through fuel controller 120 to computer system 110 that then queries data storage 140 to request other information within data storage 140 relating to account number “3141592.”

Next, data storage 140 obtains associated records from a table such as table 502. In this example, data storage 140 queries records 502a through 502n looking for records associated with loyalty account “3141592.” It will be appreciated that the transaction ID “A001” associated with record 502a and transaction ID “A004” associated with 502d provide matches.

At Step 522, computer system 110 then generates a custom interface indication relating to the requested loyalty data. For example, in some embodiments, computer system 110 receives the associated Transaction Details for all records within storage device 140-1 that related to the received loyalty identifier, “3141592.” In this example, computer system would receive the transaction details “A001x” and “A004x.” Computer system 110 then generates a custom interface indication based on the received transaction details such as by generating a promotional offer based on the content within the received transaction details. For example, if transaction details “A001x” and “A004x” include an indication that the user often purchases coffee in the morning, computer system 110 determines that the current transaction is occurring in the morning and proceeds to generate a custom interface that includes a promotion offering the user an immediate discount on coffee. In some embodiments, transaction details also include data such as rewards points, available reward redemptions, rewards promotions, prior transaction records, user preferences, user demographics, or the like.

In other embodiments, computer system 110 generates a custom interface indication that includes a promotional offer or other custom content that is received from another device. For example, data storage 140 also includes the ability to generate recommendations based on the records stored therein. Data storage 140 then sends the promotion to computer system 110 when computer system 110 queries data storage 140 with a particular loyalty identifier such as “3141592.” In other examples, portions of the custom interface are generated by different systems in a manner that allow computer system 110 to assemble a final custom interface for transmission to a digital display such as a display integrated within fuel dispenser 130-1.

In some embodiments, incorporation of the retrieved loyalty information includes simply informing the user of current rewards information. For example, the custom interface includes the total number of rewards points a user has earned.

In other embodiments, the custom user interface is populated with a promotion that is generated based on knowledge derived from the retrieved loyalty information. For example, if the retrieved loyalty information indicates that the user has purchased a particular item in the past, the custom interface includes a promotion to encourage purchase of that item, or a related item, again. It should be appreciated that in addition to displaying known rewards information or suggesting promotions for known purchased items, in some embodiments the loyalty data is also used to make predictions that are then used to generate the custom interface. For example, by knowing loyalty information such as demographic information and quantity of earned rewards points, generating the custom interface at Step 522 includes predicting, based on the demographic information and the available rewards points, a particular good or service the user is interested in and then presenting an offer, promotion, or other content within the custom interface relating to that predicted interest.

Thus, at Step 524, regardless of how the custom interface was generated or assembled, computer system 110 communicates the custom interface for display at a digital display such as at fuel dispenser 130-1. It should also be noted that in some embodiments this custom interface display includes other information in addition to the promotional offer or loyalty data. For example, as was discussed previously in conjunction with FIGS. 3a through 3j, promotional offers or loyalty data can be shown during other operations such as multiple products transactions. In such embodiments, the same information used by computer system 110 to determine the user is eligible for a multiple products transaction is the information used to query data storage 140 to ascertain loyalty information for the purpose of generating promotional offers.

Once the custom interface has been generated, such as by computer system 110, the custom interface is communicated for display at the fuel dispenser 130-N. As has been discussed previously, in some embodiments, the custom interface is communicated from computer system 110 to fuel controller 120 over communications channel 156 to bypass communication controller 122. The custom interface is then passed by fuel dispenser 120, operating in interrupted mode, using communications channel 158 for display at fuel dispenser 130-N.

At Step 506, computer system 110 receives whatever response or action is taken by the user in conjunction with the custom user interface displayed at Step 524. That information is then stored as loyalty data within data storage 140 and is associated with the user. For example, assume the custom interface generated at Step 524 and displayed at the fuel dispenser 130-1 in Step 526 includes a promotion for a discount on coffee. At Step 528, the user accepting or rejecting the promotion (e.g., buy selecting yes or no in response to a prompt within the custom user interface) is then communicated back to computing system 110 for storage within data storage 140. For example, a new record 502e is generated within table 502 that includes a transaction Id “A005,” a loyalty ID “3141592,” and a transaction detail “A005x” that includes data relating to whether the user accepted or rejected the promotional offer. In some embodiments, transaction detail “A005x” also includes other metadata about the transaction such as time, date, weather, transaction duration, fuel dispenser number, or any other information determined to be helpful for tracking loyalty transactions. That loyalty information can then be used in the future to generate new custom interfaces based on loyalty information associated with the user (e.g., offering a soda instead of coffee during the next visit.)

It should also be appreciated that while the foregoing method was described with reference to displaying the custom interfaces at a fuel dispenser such as fuel dispenser 130-1, in some embodiments, alternatively or additionally, the custom interfaces are caused to be displayed at a digital display of a mobile device, such as mobile device 510 of FIG. 5a.

For example, at Step 524, computer system 110 also causes the custom display to be generated at mobile device 510 by communicating through any suitable means to mobile device 510. In some embodiments, this communication occurs in conjunction with a registered app installed on mobile device 510. For example, mobile device 510 includes a loyalty app linked to a user's loyalty account number. Upon generating the custom interface at 522, computer system 110 also communicates the custom interface at Step 524 using a push notification through the loyalty app on the mobile device. In some embodiments the user can then leverage the notification with the mobile device to accept or reject the offer, store the offer for later, present the offer inside the fueling station building for redemption, or other responses relating to the offer.

It should also be appreciated that in some embodiments the custom interface presented at the mobile device 510 differs from any custom interface presented at the fuel dispenser 130-1. For example, fuel dispenser 130-1 displays customized media like a custom video or graphic. At the same time, mobile device 510 receives a push notification that includes a promotional offer. In other embodiments, the custom interface is received only at one device.

In some embodiments, the custom interface generated for display at mobile device 510 is communicated through the fuel controller 120, the fuel dispenser 130-N, storage 140, or through some other hardware device existing within the fueling system. In other embodiments, an entirely separate communications channel 512 may be utilized allowing direct communication from computer system 110 to mobile device 140. Finally, in other embodiments, computer system 110 may interact with an entirely separate service (not shown) such as a cloud infrastructure that allows for custom screens, interactions, notifications, or other content to be pushed to mobile device 510.

### Generating Receipts for Preauthorized Transactions

Thus far, the embodiments described herein have focused largely on the ability of a computer system to bypass a fuel controller in order to cause custom information to be displayed at a fuel dispenser. For example, embodiments have been described for displaying multiple fuel transaction configuration screens and other embodiments have described the display of custom loyalty information.

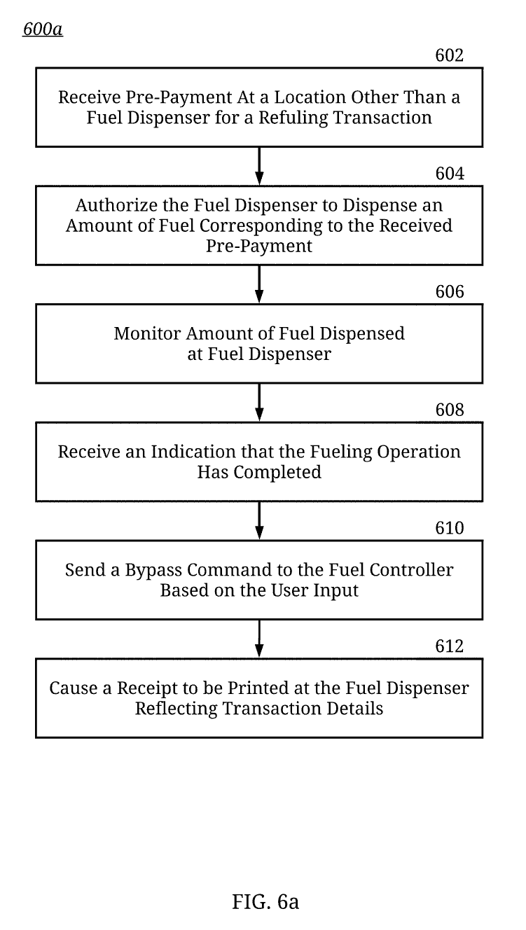

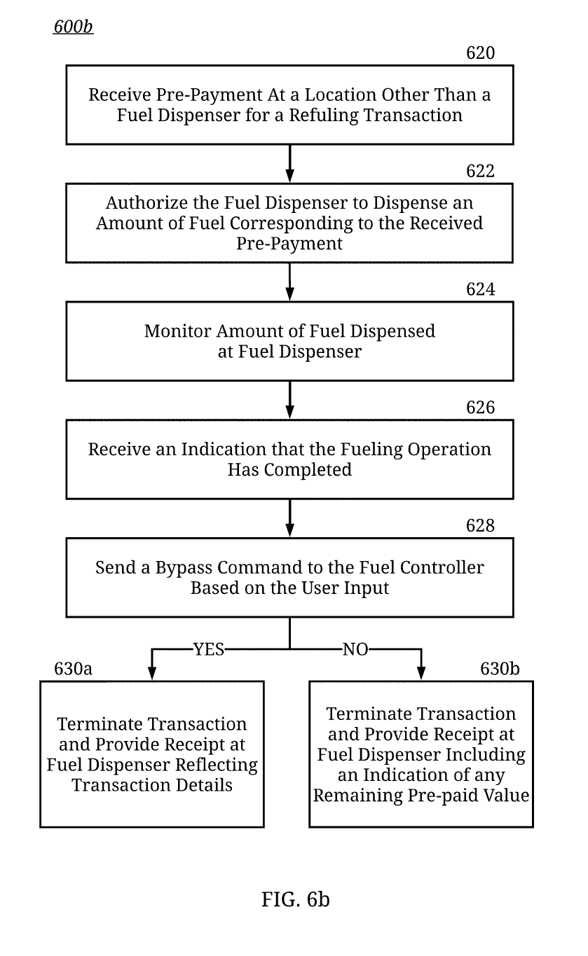

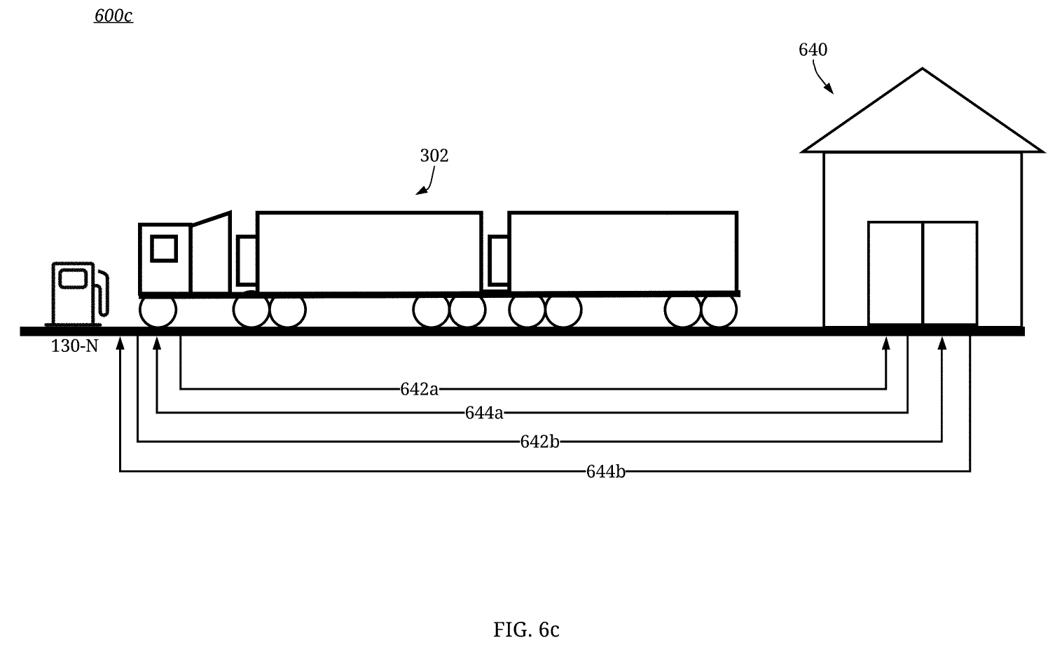

The embodiments described below in conjunction with FIGS. 6a and 6b also rely on the ability of a computer system to place a fuel controller into an interrupted state. However, rather than utilizing the interrupted state in order to display custom information at a digital display, the methods 600a and 600b instead (or additionally) utilize a fuel controller interrupt in order to generate physical receipts at fuel dispensers outside of the fueling station for transactions that were initiated somewhere other than at the fuel dispenser (e.g., at a point of sale (POS) system inside the fueling station building.)

As an improvement that makes obtaining a receipt and/or a refund more convenient, FIG. 6a illustrates a method 600a implemented at a system utilizing a fuel controller interrupt for generating receipts for fueling transactions initiated at a location other than a fuel dispenser. The method described herein enables a customer to pre-pay inside the fueling station building and obtain a receipt outside the fueling station building at the dispenser after fueling. The method 600a begins at Step 602 when a pre-payment is received prior to a fuel dispensing operation. For example, a user wanting to preauthorize a fuel dispensing operation enters a fueling station building and requests a particular fuel dispenser, such as fuel dispenser 130-1 of FIG. 1a, to be pre-authorized to dispense a certain value of fuel (e.g., $20.)

At Step 604, fuel dispenser 130-1 is authorized to dispense an amount of fuel corresponding to the received pre-payment amount. As has been discussed previously, in some embodiments, such authorization occurs through fuel controller 120 authorizing fuel dispenser 130-1.

At Step 606, the dispensing transaction is monitored at least to ensure that only the preauthorized amount of fuel is dispensed.

Next, at Step 608, computer system 110 receives an indication that the fueling operation has completed. For example, computer system receives an indication that the user has returned the fueling nozzle to fuel dispenser 130-1. In other embodiments, the completed operation indication results from the user having dispensed all of the preauthorized fuel. In another embodiment, a timeout results in the termination signal being sent. In another embodiment, the user generates the termination signal through an interaction with a display on the fuel dispenser 130-1, or by any other means (e.g., an interface at a mobile phone.)

No matter the means of receiving the indication that the operation has completed, once the indication has been received, computer system 110 executes Step 610 in which computer system 110 sends a bypass command to a fuel controller, such as fuel controller 120, placing it in an interrupted state. It should be appreciated that without sending the bypass command at this step in the process, the fuel controller would typically simply pass the transaction details back to the computer system 110 resulting in a receipt that printed at the same location the pre-authorization was initiated (e.g., inside the physical confines of the fueling station.) However, because computer system 110 invokes the bypass command at Step 610, customization of the completion of the transaction can occur. Specifically, the bypass allows execution of Step 612 that includes transmitting a command from computer system 110 that causes a receipt to be produced (e.g., printed) at fuel dispenser 130-1 reflecting transaction details (e.g., quantity and price of dispensed fuel.)

FIG. 6b illustrates a method 600b that differs slightly from method 600a. While in this embodiment, Steps 620, 622, 624, and 626 mirror the corresponding steps of the method 600a, method 600b differs during the final sequence that involves producing the receipt.

In method 600b, upon executing Step 628, computer system 110 determines that either Step 630a should be executed or Step 630b should be executed based on the nature of the indication received at Step 626. For example, if computer system 110 receives an indication at Step 626 that the user has dispensed all of the fuel that was preauthorized, computer system 110 will execute Step 630a by terminating the transaction and providing a receipt at the fuel dispenser reflecting the transaction details.

In another embodiment, computer system 110 receives an indication at Step 626 that the user has replaced the fueling nozzle back on to the fuel dispenser 130-1 prior to dispensing all of the preauthorized fuel. In that scenario, computer system 110 will place the fuel controller into the interrupted state and then execute Step 630b causing the transaction to be terminated and a receipt provided at the fuel dispenser that includes both transaction details as well as an indication of any remaining pre-paid value. For example, assume the user prepaid $20 worth of fuel. If at Step 628 computer system 110 determines that the user has replaced the fueling nozzle after only dispensing $17 worth of fuel, computer system 110 will execute Step 630b and provide a receipt that includes an indication that $3 worth of pre-paid fuel is owed to the user.

In some embodiments of method 600b, the indication of the remaining prepaid value also includes a transaction identifier linking the remaining value to a transaction record store by computer system 110. For example, upon completion of the fueling transaction, computer system 110 stores a record of the transaction at a storage device such as data storage 140 as illustrated in FIG. 1. Such a record will include a transaction identifier that enables the transaction, and corresponding owed balance, to be retrieved by querying data storage 140 at a later time.

In some embodiments, the receipt generated at the fuel dispenser does not directly include an indication of an owed remaining balance. Such embodiments may be implemented for security reasons so that if a user forgets to collect the printed receipt, a subsequent customer cannot retrieve the receipt and see the value that is available. Thus, in some embodiments, the receipt includes some transaction details, but omits others. Further, in some embodiments, the amount owed back to the customer may be displayed at the fuel dispenser display screen upon completion of the transaction such that the user is informed of the remaining balance.

In one embodiment, the transaction identifier takes the form of a barcode, alpha-numerical identifier, or a two-dimensional code such as a QR code. Upon printing the receipt at Step 630b of the method 600b, computer system 110 causes the transaction identifier to be included on the receipt. This enables the user to retrieve the available balance through the use of the transaction identifier. In some embodiments, the user can utilize the transaction identifier on the receipt during a future transaction by presenting the transaction identifier to a system that can query data storage 140. For example, the user presents the transaction identifier at the POS system inside the fueling station building to receive a refund of the associated balance or to apply the associated balance to a future transaction.

In another embodiment, a fuel dispenser such as fuel dispenser 130-1 is configured utilize the transaction identifiers provided on receipts, query data storage 140, and ultimately allow the user to utilize the remaining balance directly at fuel dispenser 130-1.

In yet another embodiment, a user is able to utilize a mobile device to retrieve the available balance. For example, upon receiving a receipt that includes a transaction identifier in the form of a QR code, a user utilizes their mobile phone to scan the QR code. Upon scanning, the available balance is then applied to a user account associated with an installed application on the mobile device.

In another embodiment, providing the receipt at Step 630a additionally includes computer system 110 automatically applying the balance to a loyalty account associated with the user. For example, in addition to providing a receipt that includes a transaction identifier tied to a record of the remaining balance, Step 630a also includes computer system 110 querying data storage 140 (or using a previous query to data storage 140, such as the query discussed at Step 206 of FIG. 2 or Step 520 from FIG. 5) to obtain loyalty account information associated with the user. Computer system 110 then applies the remaining balance to the loyalty account for future use by the user.

In order to more fully describe some of the benefits of the foregoing description of printing receipts a fuel dispenser for transactions initiated at a location other than the fuel dispenser, FIG. 6c has been provided.

FIG. 6c includes a functional diagram of a fueling station 600c. Fueling station 600c includes a fueling station building 640, a vehicle 302 that is the target of the fueling operation, and a fuel dispenser 130-N. While vehicle 302 is illustrated as a tractor with multiple semi-trailers, it should be appreciated that the present application contemplates application of this concept for any type of vehicle that can use fuel dispenser 130-N.

FIG. 6c includes four abstract representations 642, 644, 646, and 648 that illustrate advantages of the present invention, namely, how a driver of vehicle 302 may move between vehicle 302 and fueling station building 640 to complete various steps of a preauthorized fuel dispensing operation of the present invention.

For example, in one embodiment, a driver of vehicle 302 enters fueling station 600c and positions vehicle 302 at fuel dispenser 130-N. The driver then enters fueling station building 640, as illustrated by path 642a, in order to pre-pay for a particular amount of fuel. The driver then returns from building 640 to fuel dispenser 130-N as illustrated by path 644a, and dispenses fuel according to the preauthorized transaction.

According to the embodiments described above (e.g., method 600a and/or method 600b), the user then receives a receipt at fuel dispenser 130-N. Thus, in a fueling operation consistent with the improvements described within this specification, a user must only enter building 640 once during a preauthorized fueling transaction that requires preauthorization inside the building 640 while still retaining the ability to obtain a receipt at the end of the transaction.

In some embodiments, such as those described in conjunction with Step 630b of method 600b, a user does not dispense all of the fuel that has been preauthorized. Thus, as has been described, in some embodiments fuel dispenser 130-1 is caused to print a receipt that includes an indication of a remaining balance. Referring again to Method 600c, in such a scenario, a user can enter building 640 again with the receipt that includes the balance indication, as illustrated by path 642b. The user then receives the balanced owed as indicated by the receipt and returns to vehicle 302 as illustrated by path 644b. However, it must be appreciated that because the receipt was printed at fuel dispenser 130-N and included an indication of the balance owed, in some embodiments, the trips taken by the user illustrated by steps 642b and 644b are taken at a later time, and possibly at a later date. Thus, in some embodiments, a user executes a preauthorized fueling transaction and, even though the user does not dispense all of the preauthorized fuel, the user need not immediately return to building 640 to retrieve a refund of the balance. Instead, for example, in some embodiments the user retains the receipt with the included balance indication for a later redemption.

For example, in one embodiment, the user returns to fueling station 600c at a later date to complete a new fueling transaction and again parks vehicle 302 at fuel dispenser 130-N. At this point, depending on the embodiment, the user determines how to apply the balance owed from the previous transaction (and as indicated on the previous receipt) to the new fueling transaction. In one embodiment, the user chooses to redeem the balance owed by entering building 640 as illustrated by path 642b. The user then applies the balance to a new preauthorized dispensing operation. It should be appreciated that the balance can be applied as a full or partial preauthorization (e.g., the user may use the remaining balance along with an additional amount of preauthorized fuel.) The user then returns to fuel dispenser 130-N, along path 644b, to dispense the preauthorized fuel.

Thus, is should be appreciated that by providing a receipt at fuel dispenser 130-N for preauthorized transactions improves the fueling process for some users by at least reducing the number of trips a user must take back into building 640 or by allowing the user to determine when to make those trips. As a result, the fueling operations of the present invention, such as illustrated in FIG. 6c and the discussion relating thereto, are more efficient and offer a greater degree of convenience for users.

### Exemplary Computer System Configuration

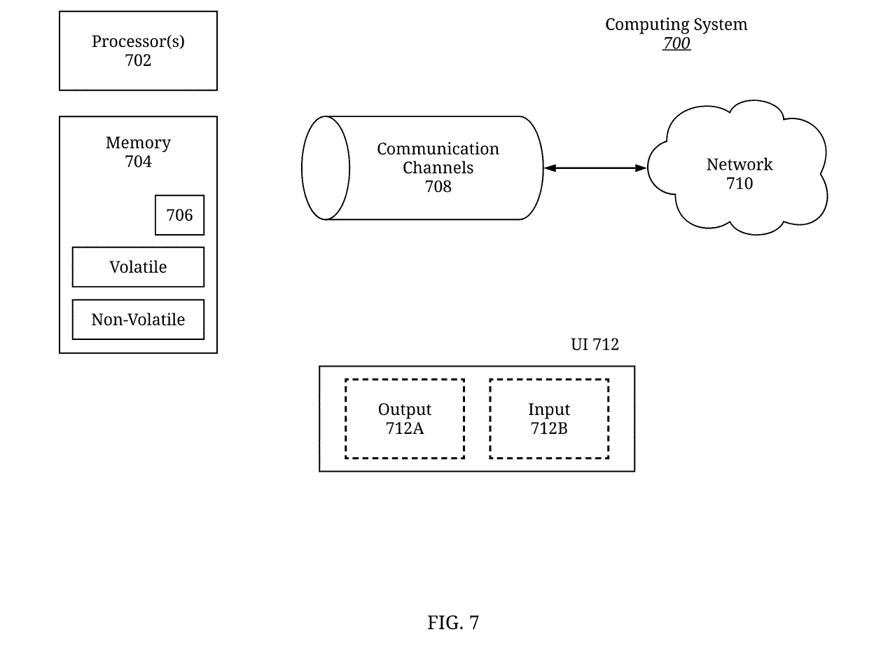

Turning now to FIG. 7, an exemplary computing system that may be used to employ embodiments described herein. For example, FIG. 7 illustrates a computer system consistent with the implementation of a computer system 110 illustrated in FIG. 1a and FIG. 1b.

Computing systems are now increasingly taking a wide variety of forms. Computing systems include, for example, handheld devices, appliances, laptop computers, desktop computers, mainframes, distributed computing systems, or even devices that have not conventionally been considered as a computing system. In this description and in the claims, the term “computing system” is defined broadly as including any device or system (or combination thereof) that includes at least one processor and a memory capable of having thereon computer-executable instructions that may be executed by the processor. The memory takes any form and may depend on the nature and form of the computing system. In some embodiments, a computing system is distributed over a network environment and includes multiple constituent computing systems.

As illustrated in FIG. 7, in its most basic configuration, a computing system 700 typically includes at least one processing unit 702 and memory 704. In some embodiments, the memory 704 is a physical system memory that includes volatile memory, non-volatile memory, or some combination of the two. The term “memory” is also used herein to refer to non-volatile mass storage such as physical storage media. If the computing system is distributed, the processing, memory and/or storage capability may be distributed as well. As used herein, the term “module” or “component” can refer to software objects or routines that execute on the computing system. The different components, modules, engines, and services described herein may be implemented as objects or processes that execute on the computing system (e.g., as separate threads).

Embodiments are described within this specification with reference to steps or acts that are performed by one or more computing systems, such as computing system 110. If such acts are implemented in software, one or more processors of the associated computing system that performs the act direct the operation of the computing system in response to having executed computer-executable instructions. An example of such an operation involves the manipulation of data. The computer-executable instructions (and the manipulated data) may be stored in the memory 704 of the computing system 700.

Part of the acts directed by the processing unit(s) 702 may be to display certain information on a display 706. The display 706 is illustrated as being a particular form in FIG. 7. However, the nature and size of the display 706 may differ depending on the physical form of the computing system 700. Since the computing system 700 may take on a wide variety of physical forms, the display 706 may also have a wide variety of physical forms.

Computing system 700 may also contain communication channels 708 that allow the computing system 700 to communicate with other message processors over, for example, network 710. Communication channels 708 are examples of communications media. Communications media typically embody computer-readable instructions, data structures, program modules, or other data in a modulated data signal such as a carrier wave or other transport mechanism and include any information-delivery media. By way of example, and not limitation, communications media include wired media, such as wired networks and direct-wired connections, and wireless media such as acoustic, radio, infrared, and other wireless media. The term computer-readable media as used herein includes both storage media and communications media.

Computing system 700 may also communicate with output module 712A and input module 712B such as by way of user interface module 712.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise physical storage and/or memory media such as RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general-purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described herein. Rather, the specific features and acts described herein are disclosed as example forms of implementing the claims.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer system for generating transaction configuration interfaces at a fuel dispenser, the system comprising:
one or more processors; and
one or more computer-readable media having stored thereon executable instructions that when executed by the one or more processors configure the computer system to perform at least the following:
communicate, from the computer system, a first indication to a fuel controller to transition the fuel controller from an uninterrupted state to an interrupted state;
based on the fuel controller being in the interrupted state, cause a configuration interface for a transaction to be displayed at a digital display of a fuel dispenser;
receive, at the computer system, user input responsive to the configuration interface;
based upon the received user input, cause one or more execution interfaces for the transaction to be displayed at the fuel dispenser;
determine, at the computer system, that the transaction has completed;
based on determining that the transaction has completed, communicate, from the computer system, a second indication to the fuel controller to transition the fuel controller from the interrupted state to the uninterrupted state.

2. The computer system according to claim 1, wherein the configuration interface comprises one or more user selectable combinations of fuel to be dispensed.

3. The computer system according to claim 2, wherein the one or more user selectable combinations of products comprise various combinations of at least three product types.

4. The computer system according to claim 3, wherein the various combinations of the at least three product types include products from the group of products comprising:
tractor fuel;
reefer fuel;
diesel emissions fluid (DEF);
unleaded fuel;
fuel additive;
fuel detergent;
blended fuel;
premium fuel;
ethanol free fuel;
diesel fuel; or
compressed natural gas.

5. The computer system according to claim 3, wherein the user input includes the selection of at least one of the one or more user selectable combinations of products.

6. The computer system according to claim 5, wherein the one or more execution interfaces are configured according to the selected one or more selected combinations of products such that the one or more execution interface allows a user to choose a first product from the selected combination of products, to be dispensed.

7. The computer system according to claim 6, wherein after dispensing the first product, the execution interface allows a user to select a second product, from the selected combination of products, to be dispensed.

8. The computer system according to claim 7, wherein after dispensing the second product, the execution interface allows a user to select a third product, from the selected combination of fuel, to be dispensed.

9. The computer system of claim 5, wherein the computer system determines that the transaction has completed when the user has dispensed all of the products according to the user selected one of the one or more user selectable combination of products.

10. A method for generating transaction configuration interfaces at a fuel dispenser, the method comprising:
communicating a first indication to a fuel controller that causes the fuel controller to enter an interrupted state;
based on the fuel controller entering the interrupted state, causing a configuration interface for a transaction to be displayed at a digital display of a fuel dispenser;
receiving user input responsive to the configuration interface;
based upon the received user input, causing one or more execution interfaces for the transaction to be displayed at the fuel dispenser;
determining that the transaction has completed;
based on determining that the transaction has completed, communicating a second indication to the fuel controller that causes the fuel controller to enter an uninterrupted state.

11. The method of claim 10, wherein the configuration interface comprises one or more user selectable combinations of products for dispensing.

12. The method of claim 11, wherein the one or more user selectable combinations of products comprises various combinations of at least three product types.

13. The method of claim 12, wherein the various combinations of the at least three product types comprise:
a first product type and second product type;
the first product type and a third product type;
the second product type and the third product type; or
the first product type, the second product type, and the third product type.

14. The method of claim 12, wherein the user input includes the selection of at least one of the one or more user selectable combinations of products.

15. The method of claim 14, wherein the one or more execution interfaces include input options for the selected one or more selected combinations of products such that the one or more execution interface enables a user to choose a first product from the selected combination of products, to be dispensed.

16. The method of claim 15, wherein after dispensing the first product, the execution interface enables a user to select a second product, from the selected combination of products, to be dispensed.

17. The method of claim 16, wherein after dispensing the second product, the execution interface allows a user to select a second product, from the selected combination of products, to be dispensed.

18. The method of 12, wherein determining that the transaction has completed comprises determining the user has dispensed all of the products according to the user selected one or more user selectable combination of products.

19. The method of claim 12, wherein determining that the transaction has completed comprises determining that the user manually cancelled the transaction prior to dispensing all of the products according to the selected combination of products.

20. The method of claim 12, wherein determining that the transaction has completed comprises determining that a time-out has occurred.

21. The method of claim 12, wherein determining that the transaction has complete comprises determining that the user has met a pre-authorization threshold prior to dispensing all of the products according to the selected combination of products.

22. A computer system for generating transaction configuration interfaces at a digital display, the system comprising:
one or more processors; and
one or more computer-readable media having stored thereon executable instructions that when executed by the one or more processors configure the computer system to perform at least the following:
communicate, from the computer system, an indication to a fuel controller to transition the fuel controller from an uninterrupted state to an interrupted state;
based on the fuel controller being in the interrupted state, cause a configuration interface for a transaction to be generated at a digital display;
receive, at the computer system, user input responsive to the configuration interface;
based upon the received user input, cause one or more execution interfaces for the transaction to be generated at the digital display;
determine, at the computer system, that the transaction has completed;
based on determining that the transaction has completed, communicate, from the computer system, an indication to the fuel controller to transition the fuel controller from the interrupted state to the uninterrupted state.

23. The computer system according to claim 22, wherein the digital display comprises a mobile computing device.

24. The computer system according to claim 22, wherein the digital display comprises a display integrated within a vehicle corresponding to the transaction.

25. The computer system according to claim 22, wherein the configuration interface comprises one or more user selectable products for dispensing, at least one of the one or more user selectable products comprising electrical power.

26. The computer system according to claim 22, wherein causing the configuration interface to be generated at the digital display comprises formulating the content of the configuration interface at the computing system and transmitting the formulated content to the digital display.

27. The computer system according to claim 22, wherein causing the configuration interface to be generated at the digital display comprises identifying, at a storage device, a pre-formulated configuration interface.

28. The computer system according to claim 27, wherein as a result of identifying the pre-formulated configuration interface, the computer system is configured to cause the pre-formulated configuration interface to be displayed at the digital display.

29. The computer system according to claim 28, wherein the pre-formulated configuration interface is stored at the fuel controller.

30. The computer system according to claim 29, wherein causing the digital display to display the pre-formulated configuration interface comprises:
sending a first command to the fuel controller that includes an identifier for the pre-formulated configuration interface; and
sending a second command to the fuel controller that causes the identified pre-formulated configuration interface to be displayed at the fuel dispenser.

31. The computer system according to claim 28, wherein the pre-formulated configuration interface is stored at a fuel dispenser.

32. The computer system according to claim 31, wherein causing the digital display to display the pre-formulated configuration interface comprises:
sending a first command to the fuel controller that includes an identifier for the pre-formulated configuration interface stored at the fuel dispenser; and
sending a second command to the fuel controller that causes the identified pre-formulated configuration interface to be displayed at the fuel dispenser.

33. The computer system of claim 3, wherein the computer system additionally performs the following:
receive, from the user, a selective sequence chosen by the user, the selective sequence identifying both the product types to be dispensed and a particular order to dispense the identified product types.

34. The method of claim 11, wherein different types of products are selected in a selective sequence chosen by the user.

35. The computer system of claim 22, wherein the user input received at the computer system responsive to the configuration interface comprises a selective sequence, chosen by the user, of different types of products and an order of dispensing the different types of products.
